(19) United States
(12) Patent Application Publication
(10) Pub. No.: US 2010/0067140 A1
(43) Pub. Date: Mar. 18, 2010

(54) Disk-Drive Read/Write Head Retraction Velocity Control

(76) Inventors: Masaki Yamashita, Niiza-shi (JP); Chisako Ota, Nerima-ku (JP)

Correspondence Address: TEXAS INSTRUMENTS INCORPORATED, P O BOX 655474, M/S 3999, DALLAS, TX, 75265, US

(21) Appl. No.: 12/210,530

(22) Filed: Sep. 15, 2008

(51) Int. Cl. G11B 21/02

(52) U.S. Cl. 360/75; G9B/21.003

(57) ABSTRACT

One embodiment of the invention includes a voice coil motor (VCM) drive system. The system includes a VCM configured to move a read/write head across a magnetic disk in response to a current flow through the VCM. The system also includes a VCM output stage configured to direct the current through the VCM in one of a first direction corresponding to retraction of the read/write head and a second direction corresponding to extension of the read/write head in response to switching control signals. The system further includes a retract controller configured to control a retraction velocity of the read/write head by generating the switching control signals to provide the current in the first direction to increase the retraction velocity of the read/write head and to provide the current in the second direction to decrease the retraction velocity of the read/write head during a retraction mode of the VCM drive system.

### TECHNICAL FIELD

This invention relates to electronic circuits, and more specifically to disk-drive read/write head retraction velocity control.

### BACKGROUND

Magnetic disk-drives, such as hard-drives, are implemented in almost all personal computers and enterprise-class server computers. Typical magnetic disk drives are operated by a spindle motor (SPM) that spins the magnetic disk and a voice coil motor (VCM) that drives and positions the magnetic disk read and/or write head. As an example, the VCM can be a linearly operated servo motor that can operate in a seek mode and in a tracking mode. The disk-drive motor driver can also operate in a head-retraction mode. As an example, upon there being insufficient seek mode voltage to spin the SPM or to maintain adequate current through the VCM, the disk-drive motor driver can enter the head-retraction mode to generate a sufficient amount of current through the VCM to retract the magnetic disk read/write head to avoid damage to the magnetic disk. However, depending on the magnitude of the current through the VCM, the magnetic disk read/write head can be retracted too quickly, causing damage to the magnetic disk read/write head.

### SUMMARY

One embodiment of the invention includes a voice coil motor (VCM) drive system. The system includes a VCM configured to move a disk-drive read/write head across a magnetic disk in response to a VCM current flow through the VCM. The system also includes a VCM output stage configured to direct the VCM current through the VCM in one of a first direction corresponding to retraction of the read/write head and a second direction corresponding to extension of the read/write head in response to switching control signals. The system further includes a retract controller configured to control a retraction velocity of the disk-drive read/write head by generating the switching control signals to provide the VCM current in the first direction to increase the retraction velocity of the read/write head and to provide the VCM current in the second direction to decrease the retraction velocity of the read/write head during a retraction mode of the VCM drive system.

Another embodiment of the invention includes a method for controlling a retraction velocity of a disk-drive read/write head. The method includes switching a VCM drive to a retraction mode and directing a VCM current through a VCM in a first direction corresponding to retraction of the read/write head in response to switching control signals. The system also includes periodically measuring a BEMF voltage across the VCM. The system also includes directing the VCM current through the VCM in the first direction to increase the retraction velocity of the disk-drive read/write head based on a magnitude of the BEMF voltage relative to at least one threshold. The system further includes directing the VCM current through the VCM in a second direction corresponding to extension of the disk-drive read/write head to decrease the retraction velocity of the disk-drive read/write head based on the magnitude of the BEMF voltage relative to the at least one threshold.

Another embodiment of the invention includes a VCM drive system. The system includes means for directing a VCM current through the VCM in one of a first direction corresponding to retraction of a magnetic disk read/write head and a second direction corresponding to extension of the magnetic disk read/write head in response to switching control signals. The system also includes means for measuring a BEMF voltage across the VCM that corresponds to a retraction velocity of the magnetic disk read/write head. The system further includes means for controlling a retraction velocity of the magnetic disk read/write head by generating the switching control signals to direct the VCM current through the VCM in the first direction to increase the retraction velocity of the magnetic disk read/write head and to direct the VCM current through the VCM in the second direction to decrease the retraction velocity of the magnetic disk read/write head during a retraction mode of the VCM drive system.

### BRIEF DESCRIPTION OF THE DRAWINGS

FIG. 1 illustrates an example of a disk-drive motor control system in accordance with an aspect of the invention.

FIG. 2 illustrates an example of a voice-coil motor (VCM) drive in accordance with an aspect of the invention.

FIG. 3 illustrates an example of a VCM back-electromotive force (BEMF) measurement stage in accordance with an aspect of the invention.

FIG. 4 illustrates an example of a VCM switching stage in accordance with an aspect of the invention.

FIG. 5 illustrates an example of an unload torque phase for a VCM output stage in accordance with an aspect of the invention.

FIG. 6 illustrates an example of a load torque phase for a VCM output stage in accordance with an aspect of the invention.

FIG. 7 illustrates an example of an unload short discharge phase for a VCM output stage in accordance with an aspect of the invention.

FIG. 8 illustrates an example of a load short discharge phase for a VCM output stage in accordance with an aspect of the invention.

FIG. 9 illustrates an example of an unload high-impedance discharge phase for a VCM output stage in accordance with an aspect of the invention.

FIG. 10 illustrates an example of a load high-impedance discharge phase for a VCM output stage in accordance with an aspect of the invention.

FIG. 11 illustrates an example of a BEMF measurement phase for a VCM output stage in accordance with an aspect of the invention.

FIG. 12 illustrates an example of a timing diagram of a VCM switching stage in accordance with an aspect of the invention.

FIG. 13 illustrates another example of a timing diagram of a VCM switching stage in accordance with an aspect of the invention.

FIG. 14 illustrates an example of a method for controlling a retraction velocity of a disk-drive read/write head in accordance with an aspect of the invention.

### DETAILED DESCRIPTION

The invention relates to electronic circuits, and more specifically to disk-drive read/write head retraction velocity control. A voice coil motor (VCM) driver can include a retract controller for retracting a VCM motor, such as in the event of a power loss associated with the VCM or a spindle motor (SPM) of the magnetic disk-drive. Upon the VCM driver entering a retraction mode, the retract controller can be configured to periodically discharge a VCM current through the VCM to sample a magnitude of a back-electromotive force (BEMF) voltage across the VCM. The BEMF voltage can correspond to a retraction velocity of the magnetic disk read/write head. The discharge of the VCM current can result from shorting the VCM to a low voltage power rail or from directing the VCM current from the low voltage power rail through the VCM to a high voltage power rail. The sampling of the BEMF voltage can result from monitoring a voltage of the VCM relative to the low voltage power rail and providing a signal to a controller upon the voltage of the VCM becoming greater than the voltage of the low voltage power rail, thus indicating approximately zero current through the VCM.

The retract controller can set at least one threshold voltage associated with the BEMF voltage and compare the sampled BEMF voltage with the at least one threshold voltage. The at least one threshold can be a high and low threshold corresponding respectively to a maximum and minimum desired retraction velocity of the magnetic disk read/write head. The retract controller can thus direct VCM current through the VCM in a first direction corresponding to retraction of the magnetic disk read/write head to increase a speed of retraction of the magnetic disk read/write head or in a second direction corresponding to extension of the magnetic disk read/write head to decrease a speed of retraction of the magnetic disk read/write head based on the comparison of the sampled BEMF voltage with the at least one threshold voltage. As an example, the VCM current can be provided through the VCM in the first direction for a specific duration in response to the BEMF voltage being less than a low threshold and can be provided through the VCM in the second direction for a specific duration in response to the BEMF voltage being greater than a high threshold. In addition, the VCM current can be provided through the VCM in the first direction for a lesser duration or not at all upon the BEMF voltage being between the high and low thresholds.

As described herein, it is to be understood that the terms “retraction” and “retract direction” with regard to a magnetic disk read/write head are used to describe motion of the read/write head toward a neutral or inactive position, such as upon power loss or deactivation of the associated magnetic disk-drive. Similarly, the terms “extension” and “extend direction” with regard to a magnetic disk read/write head are used to describe motion of the read/write head away from a neutral or inactive position, such as to write data to and/or read data from the magnetic disk from the neutral or inactive position. Therefore, the terms “retraction” and “retract direction” can refer to either inner or outer radial motion of the read/write head with respect to a center of the magnetic disk, with the terms “extension” and “extend direction” referring to the opposite direction, depending on a location of the neutral or inactive position of the read/write head of the magnetic disk-drive.

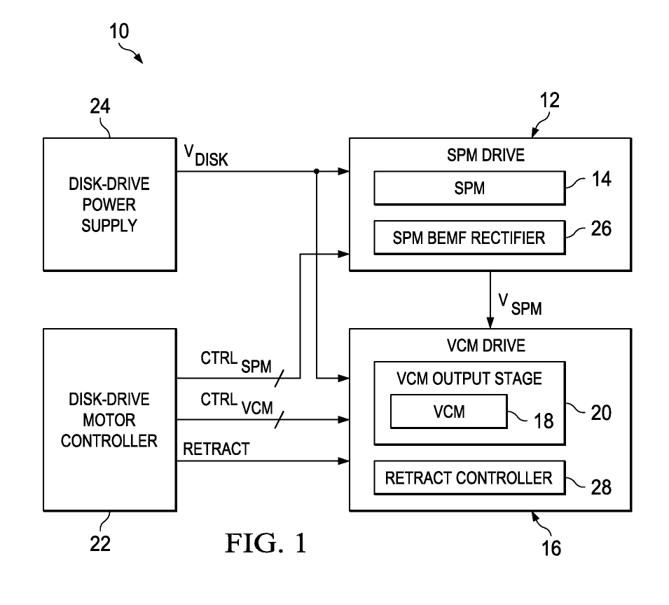

FIG. 1 illustrates an example of a disk-drive motor control system 10 in accordance with an aspect of the invention. The disk-drive motor control system 10 can be included in any of a variety of magnetic disk-drive systems, such as a hard-drive for a personal computer or laptop computer.

The disk-drive motor control system 10 includes a spindle motor (SPM) drive 12 that includes an SPM 14 configured to spin an associated magnetic disk (not shown) and a voice coil motor (VCM) drive 16 that includes a VCM 18 that drives and positions an associated magnetic disk read and/or write head (not shown). In the example of FIG. 1, the VCM drive 16 includes a VCM output stage 20 that can include a set of switches, such as configured as an H-bridge, that are coupled to the VCM 18 and can set a direction of current flow through the VCM 18. Thus, the VCM 18 can be a linearly operated servo motor configured to move the magnetic disk read/write head in one of two directions depending on the polarity of the current flow through the VCM 18 to control the position of the magnetic disk read/write head relative to the magnetic disk. Specifically, the current can be provided in a first direction through the VCM 18 to retract the read/write head and can be provided in an opposite direction through the VCM 18 to extend the read/write head.

The disk-drive motor control system 10 also includes a disk-drive motor controller 22 configured to provide command signals to the SPM drive 12 and the VCM drive 16 for operating the SPM 14 and the VCM 18. In the example of FIG. 1, the command signals are demonstrated, respectively, as a control signals CTRL_{SPM} and CTRL_{VCM}. The control signals CTRL_{SPM} and CTRL_{VCM} are representative of sets of signals that control current flow associated with the SPM 14 and the VCM 18. As an example, the control signals CTRL_{VCM} can be linear control signals that are provided to the VCM output stage 20 that are determinative of the polarity of the current through the VCM 18. Similarly, the control signals CTRL_{SPM} can activate the SPM drive 12 to provide a three-phase current to the SPM 14 to rotate the magnetic disk.

The disk-drive motor control system 10 further includes a disk-drive power supply 24 that provides a voltage VDISK to each of the SPM drive 12 and the VCM drive 16. As an example, the disk-drive power supply 24 can be configured as a linear power supply or a pulse-width modulated (PWM) power supply. The voltage V_{DISK} can thus be provided as a power voltage for each of the respective SPM drive 12 and VCM drive 16 to generate the respective currents in response to the control signals CTRL_{SPM} and CTRL_{VCM} to control the SPM 14 and the VCM 18, respectively.

In the event of a power loss condition, such as a loss of the voltage V_{DISK}, the VCM drive 16 can enter a retraction mode. Specifically, upon a power loss, the VCM drive 16 may not be able to generate enough power to maintain positioning of the magnetic disk read/write head over the magnetic disk, which could result in damage of the magnetic disk. Thus, the disk-drive motor controller 22 can provide a signal RETRACT that commands the VCM drive 16 to enter the retraction mode. As an example, the disk-drive motor controller 22 can monitor a magnitude of the voltage V_{DISK} to determine a power loss condition, or can provide the signal RETRACT in response to any of a variety of other events. As another example, the signal RETRACT could be provided directly from the disk-drive power supply 24.

In the example of FIG. 1, the SPM drive 12 can be configured to include a back-electromotive force (BEMF) rectifier 26 that is configured to rectify BEMF voltage associated with the SPM 14. The BEMF voltage can thus be provided to generate a voltage V_{SPM} to the VCM drive 16. Therefore, in response to a power loss of the voltage V_{DISK}, the VCM drive 16 can be powered by the voltage V_{SPM} to retract the magnetic disk read/write head via the VCM 18. Furthermore, the VCM drive 16 can include a retract controller 28 that is configured to command the VCM output stage 20 to control the retraction velocity of the magnetic disk read/write head. Specifically, the retract controller 28 can be configured to ensure that the magnetic disk read/write head is retracted quickly enough to avoid damage to the magnetic disk resulting from contact of the read/write head with the magnetic disk. In addition, the retract controller 28 can also be configured to ensure that the retraction velocity of the magnetic disk read/write head is not too great to avoid damage to the read/write head resulting from a collision of the read/write head with a retraction stop ramp at too great a force.

As an example, the retract controller 28 can periodically sample a BEMF voltage across the VCM 18 that can be induced in the VCM 18 via a permanent magnet in the VCM drive 16. The BEMF voltage across the VCM 18 can thus be indicative of an instantaneous retraction velocity of the read/write head. The retract controller 28 can thus compare the sampled BEMF voltage across the VCM 18 with one or more predetermined thresholds that can be indicative of a desired retraction velocity of the read/write head. Upon determining that the retraction velocity of the read/write head is not fast enough, the retract controller 28 can command a current flow through the VCM 18 in the retraction direction to increase the retraction velocity of the read/write head. Conversely, upon determining that the retraction velocity of the read/write head is too fast, the retract controller 28 can command a current flow through the VCM 18 in the extension direction to decrease the retraction velocity of the read/write head. Accordingly, the retraction velocity of the read/write head can be controlled to prevent damage to both the magnetic disk and the read/write head in a very efficient manner. As an example, the VCM drive 16 could draw as little as 20-30 μA during the retraction mode from the voltage V_{SPM}, thus greatly conserving power consumption.

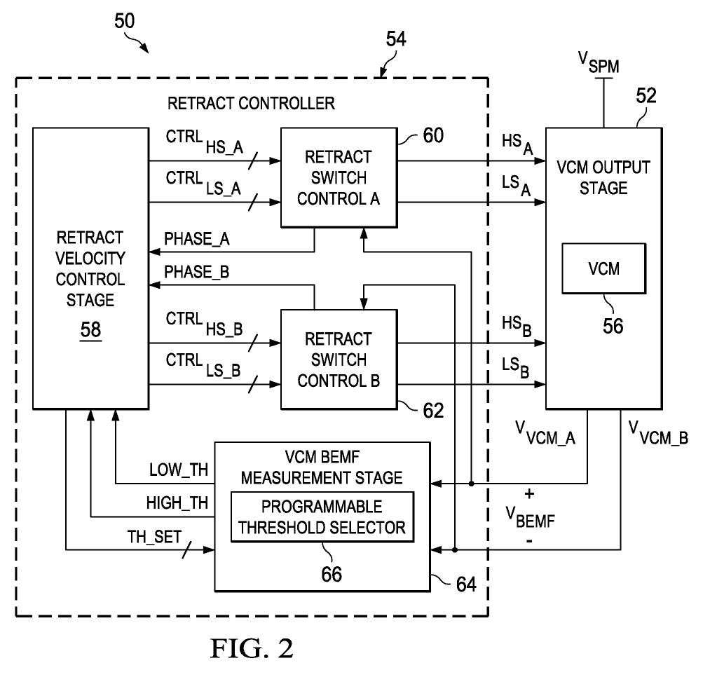

FIG. 2 illustrates an example of a VCM drive 50 in accordance with an aspect of the invention. The VCM drive 50 can be configured substantially similar to the VCM drive 16 in the example of FIG. 1. Therefore, reference is to be made to the example of FIG. 1 in the following description of the example of FIG. 2.

The VCM drive 50 includes a VCM output stage 52 and a retract controller 54. Similar to as described above, the VCM output stage 52 can include a set of switches, such as configured as an H-bridge, that are coupled to a VCM 56 to set a direction of current flow through the VCM 56. Therefore, the VCM output stage 52 can move the magnetic disk read/write head in one of two directions depending on the polarity of the current flow through the VCM 56 to control the position of the magnetic disk read/write head relative to the magnetic disk. Specifically, the current can be provided in a first direction through the VCM 56 to retract the read/write head and can be provided in an opposite direction through the VCM 56 to extend the read/write head.

The retract controller 54 includes a retract velocity control stage 58. The retract velocity control stage 58 is configured to generate sets of control signals that correspond to directional control of the VCM 56 in the retraction mode. Specifically, the retract velocity control stage 58 provides a set of high-side control signals CTRL_{HS}_{_{—}}_{A} and a set of low-side control signals CTRL_{LS}_{_{—}}_{A} to a first retract switch controller 60, demonstrated in the example of FIG. 2 as RETRACT SWITCH CONTROL A. Likewise, the retract velocity control stage 58 provides a set of high-side control signals CTRL_{HS}_{_{—}}_{B} and a set of low-side control signals CTRL_{LS}_{_{—}}_{B} to a second retract switch controller 62, demonstrated in the example of FIG. 2 as RETRACT SWITCH CONTROL B. The first and second retract switch controllers 60 and 62 can be configured to control switches on opposite sides, respectively, of the VCM output stage 52 based on the high-side control signals CTRL_{HS}_{_{—}}_{A} and CTRL_{HS}_{_{—}}_{B} and the low-side control signals CTRL_{LS}_{_{—}}_{A} and CTRL_{LS}_{_{—}}_{B}.

As an example, the high-side control signals CTRL_{HS}_{_{—}}_{A} and CTRL_{HS}_{_{—}}_{B} and the low-side control signals CTRL_{LS}_{_{—}}_{A} and CTRL_{LS}_{_{—}}_{B} can have logic states that correspond to a specific phase of the retraction mode. For example, the phases of the retraction mode can include an unload torque phase, a load torque phase, unload and load discharge phases, and a BEMF measurement phase. In the example of FIG. 2, the first retract switch controller 60 can thus generate a high switching signal HS_{A} and a low-side switching signal LS_{A} to control a respectively high and low-side switch of the VCM output stage 52 in response to the high and low-side control signals CTRL_{HS}_{_{—}}_{A} and CTRL_{LS}_{_{—}}_{A}, respectively. Likewise, the second retract switch controller 62 can thus generate a high switching signal HS_{B} and a low-side switching signal LS_{B} to control another respective high and low-side switch of the VCM output stage 52 in response to the high and low-side control signals CTRL_{HS}_{_{—}}_{B} and CTRL_{LS}_{_{—}}_{B}, respectively.

The retract controller 54 also includes a VCM BEMF measurement stage 64. The VCM BEMF measurement stage is configured to monitor a BEMF voltage V_{BEMF} across the VCM 56. In the example of FIG. 2, the BEMF voltage V_{BEMF} across the VCM 56 is demonstrated as a difference between a voltage V_{VCM}_{_{—}}_{A} and V_{VCM}_{_{—}}_{B}. As an example, the voltages V_{VCM}_{_{—}}_{A} and V_{VCM}_{_{—}}_{B} can be respective voltages at opposite ends of the VCM 56. For example, during a BEMF measurement phase, one of the ends of the VCM 56 can be coupled to a low voltage power rail, such as ground, such that the VCM BEMF measurement stage 64 can measure one of the voltages V_{VCM}_{_{—}}_{A} and V_{VCM}_{_{—}}_{B} relative to ground.

In the example of FIG. 2, the VCM BEMF measurement stage 64 includes a programmable threshold selector 66. The programmable threshold selector 66 is configured to generate at least one threshold with which the VCM BEMF measurement stage 64 compares the BEMF voltage V_{BEMF}. As demonstrated in the example of FIG. 2, the retract velocity control stage 58 provides one or more digital threshold select signals TH_SET to the VCM BEMF measurement stage 64. The programmable threshold selector 66 can thus set the one or more thresholds based on the digital threshold select signals TH_SET.

As an example, the programmable threshold selector 66 can include a pair of resistive-ladder circuits that each include an arrangement of switches that are controlled by a respective one of the digital threshold select signals TH_SET. For example, each of the pair of resistive-ladder circuits can correspond to a separate threshold, such as to generate a high threshold and a low threshold. Thus, the BEMF voltage V_{BEMF} can be compared with each of the high threshold and the low threshold. Therefore, the VCM BEMF measurement stage 64 can provide a digital signal LOW_TH and/or a digital signal HIGH_TH to the retract velocity control stage 58 to indicate a magnitude of the BEMF voltage V_{BEMF} relative to the high and low thresholds. Accordingly, the retract velocity control stage 58 can command an appropriate direction of current flow through the VCM 56 via the high-side control signals CTRL_{HS}_{_{—}}_{A} and CTRL_{HS}_{_{—}}_{B} and low-side control signals CTRL_{LS}_{_{—}}_{A} and CTRL_{LS}_{_{—}}_{B} in response to the digital signals LOW_TH and HIGH_TH. Furthermore, it is to be understood that the programmable threshold selector 66 is not limited to generating two thresholds to provide the respective two digital signals LOW_TH and HIGH_TH. As an example, the programmable threshold selector 66 can be configured to generate a plurality of thresholds, such that the thresholds define ranges of the BEMF voltage V_{BEMF} in which the retract velocity control stage 58 can operate at different phases to provide the current through the VCM 56 in corresponding directions for corresponding durations of time.

As indicated above, the retract controller 54 can cycle through several different phases of operation during the retraction mode. As an example, the retract controller 54 can operate in a BEMF measurement phase, an unload torque phase, a load torque phase, an unload discharge phase, and a load discharge phase. The BEMF measurement phase can correspond to a phase during which the BEMF voltage V_{BEMF} is sampled. The unload torque phase can correspond to directing current through the VCM 56 in the direction that corresponds to retracting the read/write head, such as to increase the retraction velocity of the read/write head. The load torque phase can correspond to directing current through the VCM 56 in the direction that corresponds to extending the read/write head, such as to decrease the retraction velocity of the read/write head. The unload and load discharge phases can correspond to discharging substantially all of the current that flows in the respective direction through the VCM 56 to obtain an accurate measurement of the BEMF voltage V_{BEMF}. Specifically, at a given time, the difference between the voltages V_{VCM}_{_{—}}_{A} and V_{VCM}_{_{—}}_{B} includes not only the BEMF voltage V_{BEMF}, but also any voltage resulting from current flow through the VCM 56. Therefore, the retract controller 54 can cycle through a sequence of one of the unload and load discharge phases to set the current through the VCM 56 to substantially zero, to the BEMF measurement phase to sample the BEMF voltage V_{BEMF}, to one of the unload and load torque phases to adjust the retraction velocity of the read/write head, then back to a respective discharge phase, and so forth during the retraction mode until the read/write head is fully retracted.

The timing of each of the operating phases of the retract velocity control stage 58 throughout the retraction mode can be programmable, such as via an EEPROM (not shown). For example, the retract velocity control stage 58 can operate in the unload and load torque phases for a first predetermined duration in response to the BEMF voltage V_{BEMF} being less than the low threshold or greater than the high threshold, respectively. As another example, the retract velocity control stage 58 can operate in the unload torque phase for a second, lesser predetermined duration in response to the BEMF voltage V_{BEMF} being between the low and high thresholds. As yet another example, the second, lesser predetermined duration can be approximately zero. As such, the retract velocity control stage 58 can continuously sample the BEMF voltage V_{BEMF} when it is between the high and low thresholds and only operate in the unload torque phase in response to the BEMF voltage V_{BEMF} dropping to a magnitude that is less than the low threshold.

Unlike the unload and load torque phases, the duration of the unload and load discharge phases is not predetermined because the duration is based on an amount of time that it takes for the current through the VCM 56 to reach a magnitude of approximately zero. Therefore, the first and second retract switch controllers 60 and 62 can each be configured to monitor a magnitude of the voltage V_{VCM}_{_{—}}_{A} and the voltage V_{VCM}_{_{—}}_{B}, respectively, relative to the low voltage power rail, such as ground. For example, the first retract switch controller 60 can monitor the voltage V_{VCM}_{_{—}}_{A} during the load discharge phase and the second retract switch controller 62 can monitor the V_{VCM}_{_{—}}_{B} during the unload discharge phase.

As an example, while the VCM 56 is discharging, the respective one of the voltages V_{VCM}_{_{—}}_{A} and V_{VCM}_{_{—}}_{B} can be negative relative to the low voltage power rail. Upon the current being substantially completely discharged from the VCM 56, the respective one of the voltages V_{VCM}_{_{—}}_{A} and V_{VCM}_{_{—}}_{B} becomes substantially equal relative to the low voltage power rail. In response, the first or second retract switch controller 60 or 62 can generate a signal PHASE_A or PHASE_B, respectively, to indicate completion of the load or unload discharge phase, respectively, to the retract velocity control stage 58. Accordingly, the retract velocity control stage 58 can accurately sample the BEMF voltage V_{BEMF} at the conclusion of the respective load or unload discharge phase based on the logic states of the signals LOW_TH and HIGH_TH.

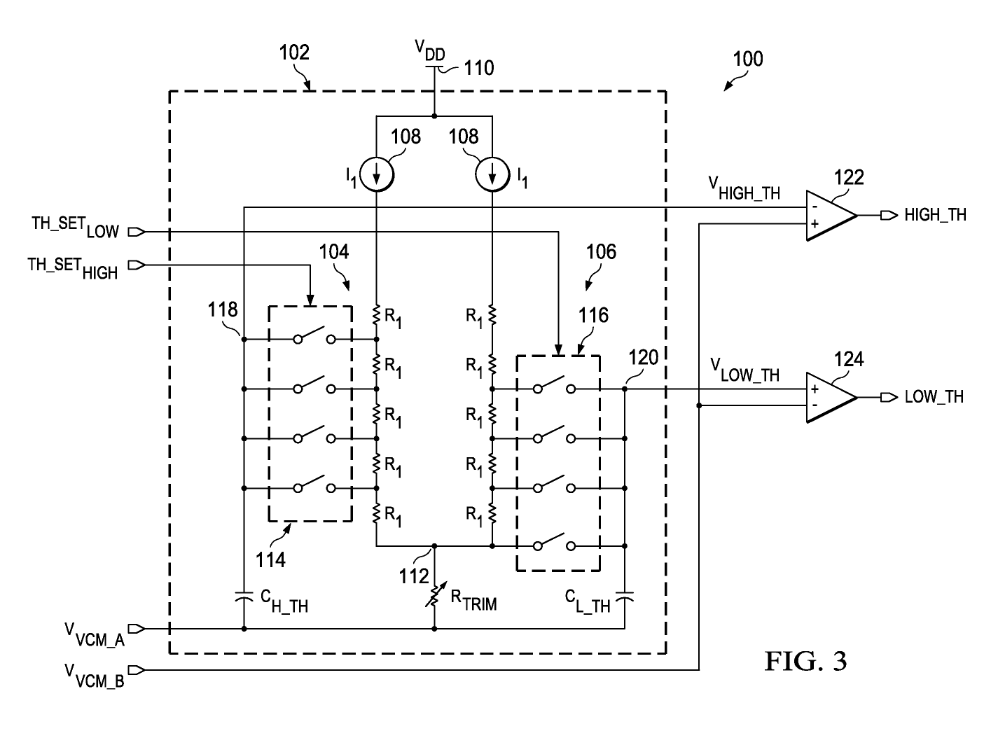

FIG. 3 illustrates an example of a VCM BEMF measurement stage 100 in accordance with an aspect of the invention. The VCM BEMF measurement stage 100 can be included in the retract controller 54 in the example of FIG. 2, such as being configured substantially similar to the VCM BEMF measurement stage 64. Therefore, reference is to be made to the example of FIG. 2 in the following description of the example of FIG. 3.

The VCM BEMF measurement stage 100 includes a programmable threshold selector 102, such as similar to the programmable threshold selector 66 in the example of FIG. 2. The programmable threshold selector 102 includes a first resistive-ladder circuit 104 and a second resistive-ladder circuit 106. Each of the first and second resistive-ladder circuits 104 and 106 includes a current supply 108 that provides a current 11 from a high voltage power rail 110 having a voltage magnitude of V_{DD}. As an example, the voltage V_{DD} can correspond to the voltage V_{SPM}, or can be provided from a separate power supply.

Each of the first and second resistive-ladder circuits 104 and 106 also include a plurality of voltage-dividing resistors R₁ arranged in series between the current supplies 108 and a node 112. While each of the voltage-dividing resistors R₁ are demonstrated as having the same resistance, it is to be understood that the voltage-dividing resistors R₁ could have different resistance values with respect to each other or between the first and second resistive-ladder circuits 104 and 106. The first resistive-ladder circuit 104 includes a switch bank 114 that is coupled to the voltage-dividing resistors in the first resistive-ladder circuit 104 at each of the nodes between the voltage-dividing resistors R₁ from between the first and second voltage-dividing resistors R₁ to between the fourth and fifth voltage-dividing resistors R₁. Similarly, the second resistive-ladder circuit 106 includes a switch bank 116 that is coupled to the voltage-dividing resistors in the second resistive-ladder circuit 106 at each of the nodes between the voltage-dividing resistors R₁ from between the second and third voltage-dividing resistors R₁ to the node 112. In addition, an adjustable resistor R_{TRIM} couples the node 112 to the voltage V_{VCM}_{_{—}}_{A}. The adjustable resistor R_{TRIM} can be adjusted to provide offset trim with respect to the high and low thresholds.

The switch bank 114 is controlled by a digital signal TH_SET_{HIGH} that can be a portion of the digital signal TH_SET provided by the retract velocity control stage 58, as described above in the example of FIG. 2. As an example, the digital signal TH_SET_{HIGH} can be a decoded signal that can activate a respective one of the switches in the switch bank 114 to couple one or more of the voltage-dividing resistors R₁ to a node 118 depending on which of the switches of the switch bank 114 is activated. Therefore, the digital signal TH_SET_{HIGH} can set a magnitude of a high threshold voltage V_{HIGH}_{_{—}}_{TH} at the node 118 based on which of the switches of the switch bank 114 is activated relative to the voltage V_{VCM}_{_{—}}_{A}. In addition, the first resistive-ladder circuit 104 includes a capacitor C_{H}_{_{—}}_{TH} that separates the node 118 from the voltage V_{VCM}_{_{—}}_{A} to mitigate transient effects on the difference between the high threshold voltage V_{HIGH}_{_{—}}_{TH} with respect to the voltage V_{VCM}_{_{—}}_{A}.

Similar to the switch bank 114, the switch bank 116 is controlled by a digital signal TH_SET_{LOW} that can also be a portion of the digital signal TH_SET provided by the retract velocity control stage 58, as described above in the example of FIG. 2. The digital signal TH_SET_{LOW} can likewise be a decoded signal that can activate a respective one of the switches in the switch bank 116 to couple one or more of the voltage-dividing resistors R₁ to a node 120 depending on which of the switches of the switch bank 116 is activated. Therefore, the digital signal TH_SET_{LOW} can set a magnitude of a low threshold voltage V_{LOW}_{_{—}}_{TH} at the node 120 based on which of the switches of the switch bank 116 is activated relative to the voltage V_{VCM}_{_{—}}_{A}. In addition, the second resistive-ladder circuit 106 includes a capacitor C_{L}_{_{—}}_{TH} that separates the node 120 from the voltage V_{VCM}_{_{—}}_{A} to mitigate transient effects on the difference between the low threshold voltage V_{LOW}_{_{—}}_{TH} with respect to the voltage V_{VCM}_{_{—}}_{A}. Further, as demonstrated in the example of FIG. 3, the position of the switch bank 116 relative to the switch bank 114 with respect to the voltage-dividing resistors R₁ is such that the low threshold voltage V_{LOW}_{_{—}}_{TH} can have a lesser magnitude than the high threshold voltage V_{HIGH}_{_{—}}_{TH} for substantially equal resistance values of the voltage-dividing resistors R₁ and the same values of the digital signals TH_SET_{HIGH} and TH_SET_{LOW}.

The VCM BEMF measurement stage 100 includes a first comparator 122 and a second comparator 124. The first comparator 122 receives the high threshold voltage V_{HIGH}_{_{—}}_{TH} at an inverting input and receives the voltage V_{VCM}_{_{—}}_{B} at a non-inverting input. Therefore, the first comparator 122 is configured to compare the high threshold voltage V_{HIGH}_{_{—}}_{TH} and the voltage V_{VCM}_{_{—}}_{B} and to provide the signal HIGH_TH in response to voltage V_{VCM}_{_{—}}_{B} having a magnitude that is greater than the high threshold voltage V_{HIGH}_{_{—}}_{TH}. Similarly, the second comparator 124 receives the low threshold voltage V_{LOW}_{_{—}}_{TH} at a non-inverting input and receives the voltage V_{VCM}_{_{—}}_{B} at an inverting input. Therefore, the second comparator 124 is configured to compare the low threshold voltage V_{LOW}_{_{—}}_{TH} and the voltage V_{VCM}_{_{—}}_{B} and to provide the signal LOW_TH in response to voltage V_{VCM}_{_{—}}_{B} having a magnitude that is less than the low threshold voltage V_{LOW}_{_{—}}_{TH}.

During a BEMF measurement phase, the signals HIGH_TH and LOW_TH can therefore provide indication of the magnitude of the BEMF voltage V_{BEMF} relative to the high and low threshold voltages V_{HIGH}_{_{—}}_{TH} and V_{LOW}_{_{—}}_{TH}. Specifically, during the BEMF measurement phase, the retract velocity control stage 58 can command the VCM output stage 52 to couple the voltage V_{VCM}_{_{—}}_{A} to the low voltage power rail, such that the high and low threshold voltages V_{HIGH}_{_{—}}_{TH} and V_{LOW}_{_{—}}_{TH} and the voltage V_{VCM}_{_{—}}_{B} are measured with respect to the low voltage power rail. As described previously, the BEMF voltage V_{BEMF} is a difference between the voltages V_{VCM}_{_{—}}_{A} and V_{VCM}_{_{—}}_{B}. Accordingly, the retract velocity control stage 58 is provided with an indication of the magnitude of the BEMF voltage V_{BEMF} relative to the high and low threshold voltages V_{HIGH}_{_{—}}_{TH} and V_{LOW}_{_{—}}_{TH}. As a result, the retract velocity control stage 58 can switch to the unload torque phase in response to the BEMF voltage V_{BEMF} being less than the low threshold voltage V_{LOW}_{_{—}}_{TH}, as indicated by the signal LOW_TH, or can switch to the load torque phase in response to the BEMF voltage V_{BEMF} being greater than the high threshold voltage V_{HIGH}_{_{—}}_{TH}, as indicated by the signal HIGH_TH.

It is to be understood that the VCM BEMF measurement stage 100 is not intended to be limited to the example of FIG. 3. For example, the example of FIG. 3 demonstrates only four switches in each of the switch banks 114 and 116 relative to only five voltage-dividing resistors R₁. However, it is to be understood that the switch banks 114 and 116 can include any number of switches relative to any number of voltage-dividing resistors R₁ in the example of FIG. 3. As another example, the digital signals LOW_TH and HIGH_TH can be provided from a latch circuit, such as to maintain a given logic-state until the state changes based on a subsequent sampling of the measured BEMF voltage V_{BEMF}.

In addition, the programmable threshold selector 102 is not limited to including only two resistive-ladder circuits to generate corresponding thresholds. As an example, the programmable threshold selector 102 can be configured to generate a plurality of thresholds that define multiple phases of operation of the retract velocity control stage 58, with each phase defining a current direction through the VCM 56 and a corresponding duration of time at which the current is provided through the VCM 56. For example, four thresholds can be defined, with each providing a separate digital signal to the retract velocity control stage 58. Therefore, the retract velocity control stage 58 can operate in five separate phases that each dictate a separate combination of current direction and duration through the VCM 56 based on the magnitude of the BEMF voltage V_{BEMF} relative to the four thresholds.

Furthermore, the VCM BEMF measurement stage 100 can include additional circuitry that can generate the high and low threshold voltages V_{HIGH}_{_{—}}_{TH} and V_{LOW}_{_{—}}_{TH} relative to the voltage V_{VCM}_{_{—}}_{B} instead of the voltage V_{VCM}_{_{—}}_{A}. Specifically, the polarity of the BEMF voltage V_{BEMF} depends on the direction of motion of the read/write head (i.e., inner or outer radial direction with respect to the magnetic disk). As an example, the VCM drive 50 in the example of FIG. 2 can be configured to provide bidirectional velocity control of the read/write head, such as based on a digital direction selection signal. Thus, the retract direction could correspond to either inner or outer radial movement of the read/write head relative to the center of the magnetic disk depending on the setting. As a result, the VCM BEMF measurement stage 100 can include a set of switches to reverse the voltages V_{VCM}_{_{—}}_{A} and V_{VCM}_{_{—}}_{B} with respect to the resistive-ladder circuits 104 and 106 and the comparators 122 and 124. Therefore, the VCM BEMF measurement stage 100 can switch between measuring either the voltage V_{VCM}_{_{—}}_{A} or the voltage V_{VCM}_{_{—}}_{B} to determine the BEMF voltage V_{BEMF} depending on the setting that dictates which physical direction corresponds to retraction of the read/write head. As an example, the retract velocity control stage 58 can command the VCM output stage 52 to couple the voltage V_{VCM}_{_{—}}_{B} to the low voltage power rail, such that the VCM BEMF measurement stage 100 can measure the voltage V_{VCM}_{_{—}}_{A} relative to the high and low threshold voltages V_{HIGH}_{_{—}}_{TH} and V_{LOW}_{_{—}}_{TH}. Accordingly, the VCM BEMF measurement stage 100 can be configured in any of a variety of ways.

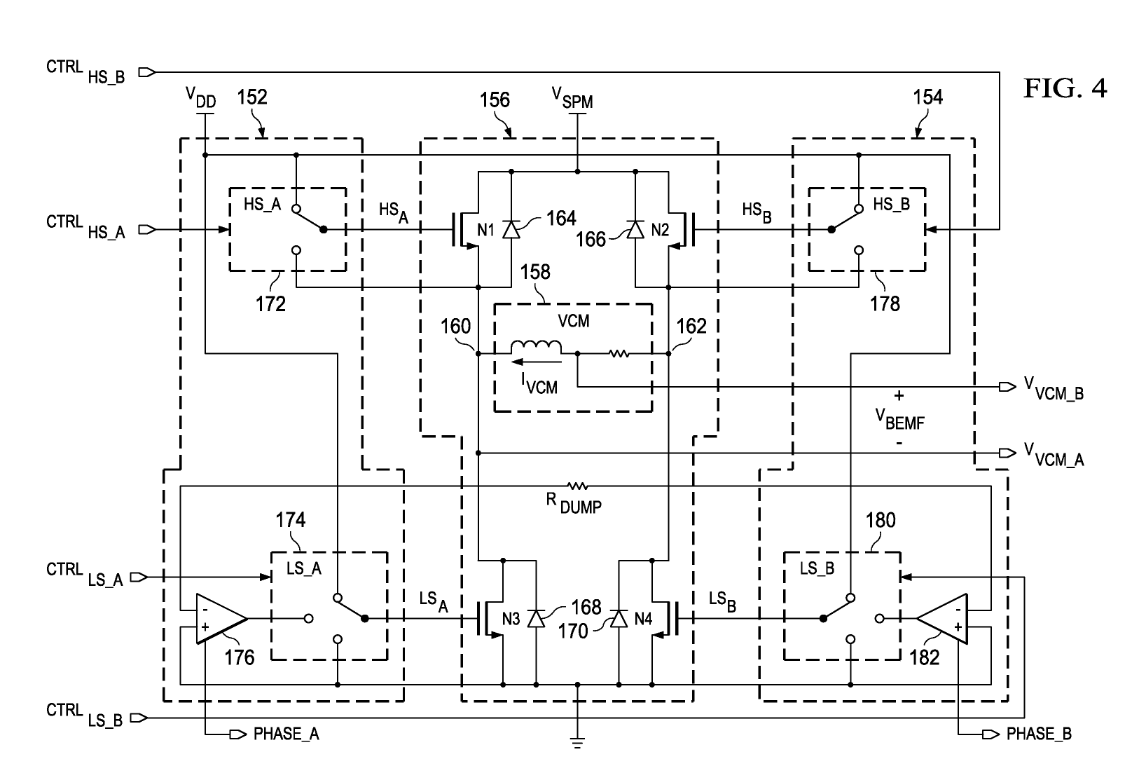

FIG. 4 illustrates an example of a VCM switching stage 150 in accordance with an aspect of the invention. The VCM switching stage 150 includes a first retract switch controller 152, a second retract switch controller 154, and a VCM output stage 156. As an example, the first and second retract switch controllers 152 and 154 can each correspond to the first and second retract switch controllers 60 and 62 in the example of FIG. 2, and the VCM output stage 156 can correspond to the VCM output stage 52 in the example of FIG. 2. Therefore, reference is to be made to the example of FIG. 2 in the following description of the example of FIG. 4.

Similar to as described above in the example of FIGS. 1 and 2, the VCM output stage 156 is configured to control the direction of a current I_{VCM} flowing through a VCM 158 based on a configuration of switches. Specifically, the VCM output stage 156 includes a first high-side transistor N1, a second high-side transistor N2, a first low-side transistor N3, and a second low-side transistor N4 that are arranged as an H-bridge with respect to the VCM 158. Specifically, the first and second high-side switches N1 and N2 interconnect a high voltage power rail, demonstrated in the example of FIG. 4 as the voltage V_{SPM}, and nodes 160 and 162 that are oppositely disposed with respect to the VCM 158. The first and second low-side switches N3 and N4 interconnect the nodes 160 and 162 with a low voltage power rail, demonstrated in the example of FIG. 4 as ground.

In addition, the VCM output stage 156 includes a diode 164 demonstrated in parallel with the first high-side transistor N1, a diode 166 demonstrated in parallel with the second high-side transistor N2, a diode 168 demonstrated in parallel with the first low-side transistor N3, and a diode 170 demonstrated in parallel with the second low-side transistor N4. As an example, the diodes 164, 166, 168, and 170 can be body diodes associated with the respective first and second high-side transistors N1 and N2 and first and second low-side transistors N3 and N4. Furthermore, a resistor R_{DUMP} interconnects the nodes 160 and 162, and can be configured to mitigate ringing of the magnitude of the BEMF voltage V_{BEMF} during a load and/or unload discharge phase. Specifically, upon a transition from a load or unload torque phase to a respective load or unload discharge phase, as explained in greater detail below, the transient response of the BEMF voltage V_{BEMF} can ripple when the current I_{VCM} is discharged from the VCM 158. Thus, the resistor R_{DUMP} mitigates the ringing (i.e., ripple) of the BEMF voltage V_{BEMF} when the current I_{VCM} is discharged from the VCM 158, such as similar to a snubber circuit. As an example, the VCM output stage 156 can include a switch (not shown) in series with the resistor R_{DUMP}, such that the resistor R_{DUMP} can be switched to be coupled in parallel with the VCM 158 based on the operating phase of the retract velocity control stage 58.

The first retract velocity control stage 152 includes a first high-side multi-state switch 172 and a first low-side multi-state switch 174, demonstrated in the example of FIG. 4 as HS_A and LS_A, respectively. As an example, the high and low-side multi-state switches 172 and 174 can each be configured as a set of transistors that can be individually activated and deactivated. The first high-side multi-state switch 172 is controlled by the digital control signal CTRL_{HS}_{_{—}}_{A} and the first low-side multi-state switch 174 is controlled by the digital control signal CTRL_{LS}_{_{—}}_{A}, respectively. As an example, the digital control signals CTRL_{HS}_{_{—}}_{A} and CTRL_{LS}_{_{—}}_{A} can be provided by the retract velocity control stage 58 in the example of FIG. 2.

The first high-side multi-state switch 172 generates a switching signal HS_{A} that is coupled to a gate of the first high-side transistor N1 based on the state of the digital signal CTRL_{HS}_{_{—}}_{A}. For example, the first high-side multi-state switch 172 can couple the gate of the first high-side transistor N1 to a high power rail voltage V_{DD} to assert the switching signal HS_{A} and thus activate the first high-side transistor N1. As an example, the voltage V_{DD} can correspond to the voltage V_{SPM}, or can be provided from a separate power supply. Similarly, the first high-side multi-state switch 172 can couple the gate of the first high-side transistor N1 to the node 160 to deactivate the first high-side transistor N1.

Similar to the first high-side multi-state switch 172, the first low-side multi-state switch 174 generates a switching signal LS_{A} that is coupled to a gate of the first low-side transistor N3 based on the state of the digital signal CTRL_{LS}_{_{—}}_{A}. For example, the first low-side multi-state switch 174 can couple the gate of the first low-side transistor N3 to the high power rail voltage V_{DD} to assert the switching signal LS_{A} and thus activate the first low-side transistor N3. Similarly, the first low-side multi-state switch 174 can couple the gate of the first low-side transistor N3 to ground to deactivate the first low-side transistor N3. In addition, the first low-side multi-state switch 174 can couple the gate of the first low-side transistor N3 to an output of an amplifier 176. The amplifier 176 has an inverting input coupled to the node 160 and a non-inverting input coupled to ground. Therefore, upon the amplifier 176 being coupled to provide the switching signal LSA, the switching signal LS_{A} can have an analog magnitude to control the first low-side transistor N3 that depends on the respective voltage magnitudes of the node 160 and ground.

The second retract switch controller 154 is configured similar to the first retract switch controller 152. Specifically, the second retract switch controller 154 includes a second high-side multi-state switch 178 that generates the switching signal HS_{B} at the gate of the second high-side transistor N2 in response to the digital control signal CTRL_{HS}_{_{—}}_{B}. Thus, the second high-side multi-state switch 178 can activate the second high-side transistor N2 by coupling the gate to the voltage V_{DD} or can deactivate the second high-side transistor N2 by coupling the gate to node 162. The second retract switch controller 154 also includes a second low-side multi-state switch 180 that generates the switching signal LS_{B} at the gate of the second low-side transistor N4 in response to the digital control signal CTRL_{LS}_{_{—}}_{B}. Thus, the low-side multi-state switch 180 can activate the second low-side transistor N4 by coupling the gate to the voltage V_{DD}, can deactivate the second low-side transistor N4 by coupling the gate to ground, or can couple the gate to an amplifier 182 to provide the switching signal LS_{B} at an analog magnitude that depends on the respective voltage magnitudes of the node 162 and ground.

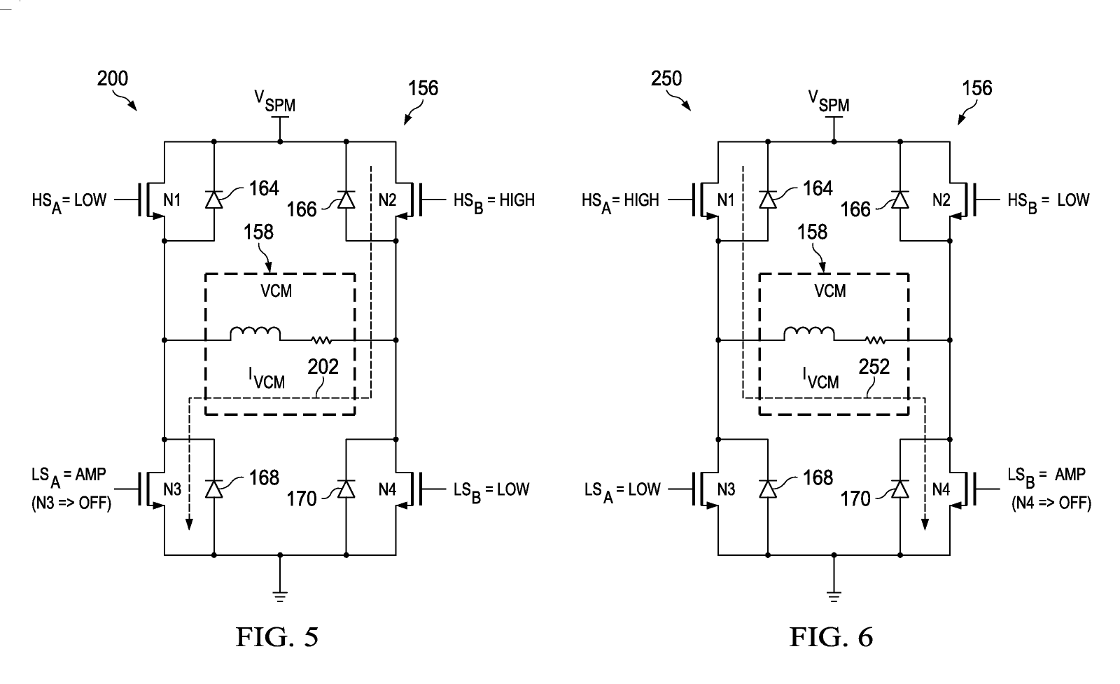

As described above in the example of FIG. 2, the retract velocity control stage 58 is configured to operate in different phases during the retraction mode. Specifically, the retract velocity control stage 58 can cycle through the phases by setting the logic states of the high and low-side control signals CTRL_{HS}_{_{—}}_{A}, CTRL_{HS}_{_{—}}_{B}, CTRL_{LS}_{_{—}}_{A}, and CTRL_{LS}_{_{—}}_{B}. As demonstrated in the example of FIG. 4, the high and low-side control signals CTRL_{HS}_{_{—}}_{A}, CTRL_{HS}_{_{—}}_{B}, CTRL_{LS}_{_{—}}_{A}, and CTRL_{LS}_{_{—}}_{B} control the states of the high and low-side transistors N1 through N4. Therefore, the different phases in which the retract velocity control stage 58 can operate can dictate the operation of the VCM output stage 156, as demonstrated below in the examples of FIGS. 5-11.

The examples of FIGS. 5-11 demonstrate the VCM output stage 156 of the example of FIG. 4. Therefore, reference is to be made to the example of FIG. 4 in the following descriptions of the examples of FIGS. 5-11. Specifically, the examples of FIGS. 5-11 demonstrate the state of the high and low-side transistors N1 through N4 to result in a direction of the current I_{VCM} through the VCM 158. It is to be understood that the first and second retract switch controllers 152 and 154 have been omitted from the examples of FIGS. 5-11, and that not all of the components of the VCM output stage 156 have been demonstrated in the examples of FIGS. 5-11, such as the resistor R_{DUMP}. Furthermore, the direction of the current I_{VCM} through the VCM 158 in each of the examples of FIGS. 5-11 is based on a specific direction of retraction of the read/write head, such as inner or outer radial movement with respect to the magnetic disk. However, it is to be understood that the direction of the current I_{VCM} through the VCM 158 could be reversed to correspond to the other direction of radial movement, such as in response to a direction selection bit, similar to as described above in the example of FIG. 3. Accordingly, the operating phases of the retract velocity control stage 58 can be reversed based on the radial direction of movement of the read/write head.

FIG. 5 illustrates an example of an unload torque phase 200 for the VCM output stage 156 in accordance with an aspect of the invention. Specifically, the unload torque phase 200 demonstrates the state of the high and low-side transistors N1 through N4 to result in a direction of the current I_{VCM}, as demonstrated by an arrow 202, through the VCM 158.

In the example of FIG. 5, the switching signal HS_{A} is demonstrated as having a logic-low state. As an example, the first high-side multi-state switch 172 is commanded to couple the gate of the first high-side transistor N1 to the node 160 based on the digital control signal CTRL_{HS}_{_{—}}_{A}. Therefore, the first high-side transistor N1 is deactivated in the example of FIG. 5. Conversely, the switching signals HS_{B} and LS_{A} are each demonstrated as having a logic-high state. As an example, the second high-side multi-state switch 178 and the first low-side multi-state switch 174 are commanded to couple the gates of the second high-side transistor N2 and the first low-side transistor N3, respectively, to the voltage V_{DD} based on the respective digital control signals CTRL_{HS}_{_{—}}_{B} and CTRL_{LS}_{_{—}}_{A}. Therefore, the second high-side transistor N2 and the first low-side transistor N3 are each activated in the example of FIG. 5. Furthermore, the switching signal LS_{B} is demonstrated as being provided from the amplifier 182 based on the digital control signal CTRL_{LS}_{_{—}}_{B}. Thus, the switching signal LS_{B} is provided as an analog signal having a magnitude, for example, of between 0 volts and a threshold voltage of the second low-side transistor N4 based on the relative magnitude of the voltage at the node 162 (e.g., the voltage V_{VCM}_{_{—}}_{B}) and ground. Therefore, the second low-side transistor N4 is deactivated.

Based on the configuration of the first high and low-side transistors N1 and N3 as well as the second high and low-side transistors N2 and N4, a current path of the current I_{VCM} through the VCM 158 is formed. Specifically, the arrow 202 demonstrates the current I_{VCM} flowing from the voltage V_{SPM}, through the second high-side transistor N2, through the VCM 158, through the first low-side transistor N3, to ground. The direction of the current I_{VCM}, as demonstrated by the arrow 202, can correspond to the retraction direction of the read/write head. Thus, the retract velocity control stage 58 can switch to the unload torque phase 200 for a predetermined and/or programmable duration to increase the retraction velocity of the read/write head, such as in response to the measured BEMF voltage V_{BEMF} being less than the low threshold voltage V_{LOW}_{_{—}}_{TH} demonstrated in the example of FIG. 3. As another example, the retract velocity control stage 58 can switch to the unload torque phase 200 in response to the measured BEMF voltage V_{BEMF} being between the high and low threshold voltages V_{HIGH}_{_{—}}_{TH} and V_{LOW}_{_{—}}_{TH} demonstrated in the example of FIG. 3, such as for a lesser predetermined and/or programmable duration than when the measured BEMF voltage V_{BEMF} is less than the low threshold voltage V_{LOW}_{_{—}}_{TH}.

FIG. 6 illustrates an example of a load torque phase 250 for the VCM output stage 156 in accordance with an aspect of the invention. Specifically, the load torque phase 250 demonstrates the state of the high and low-side transistors N1 through N4 to result in a direction of the current I_{VCM}, as demonstrated by an arrow 252, through the VCM 158.

In the example of FIG. 6, the switching signal HS_{B} is demonstrated as having a logic-low state. As an example, the second high-side multi-state switch 178 is commanded to couple the gate of the second high-side transistor N2 to the node 162 based on the digital control signal CTRL_{HS}_{_{—}}_{B}. Therefore, the second high-side transistor N2 is deactivated in the example of FIG. 6. Conversely, the switching signals HS_{A} and LS_{B} are each demonstrated as having a logic-high state. As an example, the first high-side multi-state switch 172 and the second low-side multi-state switch 180 are commanded to couple the gates of the first high-side transistor N1 and the second low-side transistor N4, respectively, to the voltage V_{DD} based on the respective digital control signals CTRL_{HS}_{_{—}}_{A} and CTRL_{LS}_{_{—}}_{B}. Therefore, the first high-side transistor N1 and the second low-side transistor N4 are each activated in the example of FIG. 6. Furthermore, the switching signal LS_{A} is demonstrated as being provided from the amplifier 176 based on the digital control signal CTRL_{LS}_{_{—}}_{A}. Thus, the switching signal LS_{A} is provided as an analog signal having a magnitude, for example, of between 0 volts and a threshold voltage of the first low-side transistor N3 based on the relative magnitude of the voltage at the node 160 (e.g., the voltage V_{VCM}_{_{—}}_{A}) and ground. Therefore, the first low-side transistor N3 is deactivated.

Based on the configuration of the first high and low-side transistors N1 and N3 as well as the second high and low-side transistors N2 and N4, a current path for the current I_{VCM} through the VCM 158 is formed. Specifically, the arrow 252 demonstrates the current I_{VCM} flowing from the voltage V_{SPM}, through the first high-side transistor N1, through the VCM 158, through the second low-side transistor N4, to ground. The direction of the current I_{VCM}, as demonstrated by the arrow 252, can correspond to the extension direction of the read/write head. Thus, the retract velocity control stage 58 can switch to the load torque phase 250 for a predetermined and/or programmable duration to decrease the retraction velocity of the read/write head, such as in response to the measured BEMF voltage V_{BEMF} being greater than the high threshold voltage V_{HIGH}_{_{—}}_{TH} demonstrated in the example of FIG. 3.

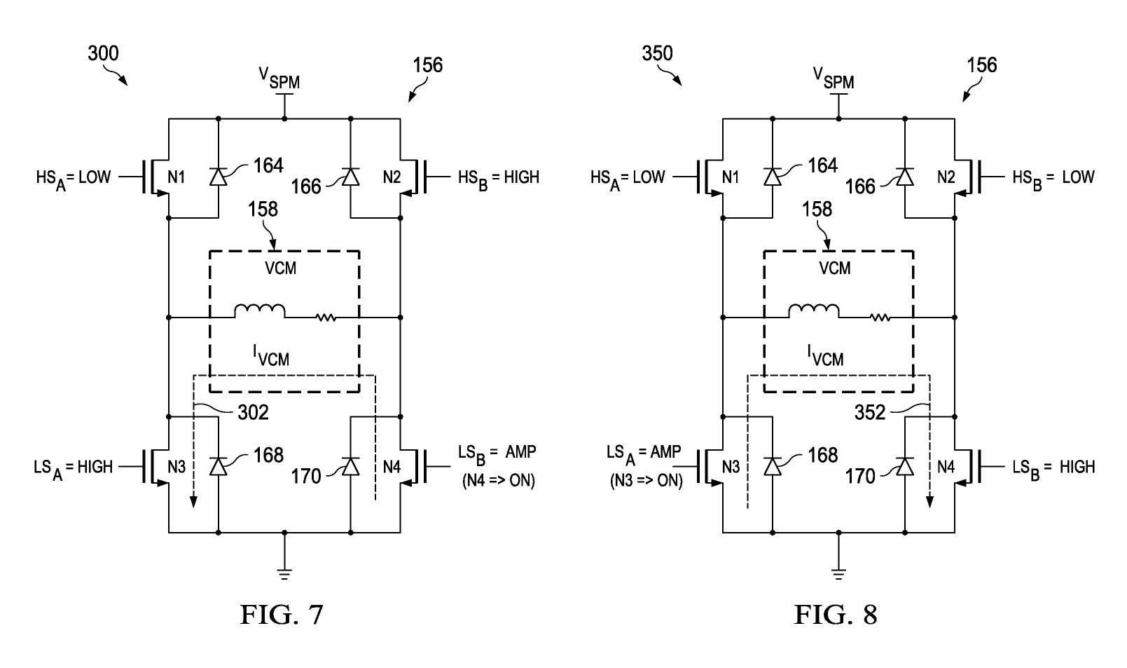

FIG. 7 illustrates an example of an unload short discharge phase 300 for the VCM output stage 156 in accordance with an aspect of the invention. Specifically, the unload short discharge phase 300 demonstrates the state of the high and low-side transistors N1 through N4 to result in a direction of the current I_{VCM}, as demonstrated by an arrow 302, through the VCM 158.

In the example of FIG. 7, the switching signals HS_{A} and HS_{B} are demonstrated as having a logic-low state. As an example, the first high-side multi-state switch 172 is commanded to couple the gate of the first high-side transistor N1 to the node 160 based on the digital control signal CTRL_{HS}_{_{—}}_{A} and the second high-side multi-state switch 178 is commanded to couple the gate of the second high-side transistor N2 to the node 162 based on the digital control signal CTRL_{HS}_{_{—}}_{B}. Therefore, the first and second high-side transistors N1 and N2 are deactivated in the example of FIG. 7. Conversely, the switching signal LS_{A} is demonstrated as having a logic-high state. As an example, the first low-side multi-state switch 174 is commanded to couple the gate of the first low-side transistor N3 to ground based on the digital control signal CTRL_{LS}_{_{—}}_{A}. Therefore, the first low-side transistor N3 is activated in the example of FIG. 7. However, as indicated in the example of FIG. 7, the gate of the second low-side transistor N4 remains coupled to the output of the amplifier 182 based on the digital control signal CTRL_{LS}_{_{—}}_{B}. As described in greater detail below, the amplifier 182 can increase the analog magnitude of the switching signal LS_{B} at a transition from the unload torque phase 200 to the unload short discharge phase 300 to activate the second low-side transistor N4.

Based on the configuration of the first high and low-side transistors N1 and N3 as well as the second high and low-side transistors N2 and N4, the current I_{VCM} through the VCM 158 begins to discharge, such as from an immediately preceding unload torque phase 200. Specifically, the inductive load of the VCM 158 maintains current flow subsequent to the unload torque phase 200, such that the retract velocity control stage 58 commands the VCM output stage 156 to discharge the current I_{VCM} through the VCM 158 prior to measuring the BEMF voltage V_{BEMF}. Thus, during the unload short discharge phase 300, the current I_{VCM} decreases as the VCM 158 discharges. Accordingly, the retract velocity control stage 58 maintains the unload short discharge phase 300 until the current I_{VCM} is substantially completely discharged (i.e., having a magnitude of approximately zero) from the VCM 158.

As described above, the gate of the second low-side transistor N4 is coupled to the output of the amplifier 182 in the unload torque phase 200 and remains coupled to the output of the amplifier 182 in the unload short discharge phase 300. Referring back to the example of FIG. 4, the amplifier 182 is configured to monitor the magnitude of the voltage at the node 162 (e.g., the voltage V_{VCM}_{_{—}}_{B}) relative to ground. Initially, upon the transition from the unload torque phase 200 to the unload short discharge phase 300, the magnitude of the voltage V_{VCM}_{_{—}}_{B} rapidly decreases to a negative magnitude to maintain the current I_{VCM} through the VCM 158. The amplifier 182 thus tracks the magnitude of the voltage V_{VCM}_{_{—}}_{B} at its output, and thus provides the switching signal LS_{B} as having a magnitude approximately equal to the magnitude of the voltage V_{VCM}_{_{—}}_{B}. Initially, the current I_{VCM} flows from ground through the diode 170 based on an inherent delay in the bandwidth performance of the amplifier 182. However, because the analog magnitude of the switching signal LS_{B} was between 0 volts and a threshold voltage of the second low-side transistor N4 during the unload torque phase 200, the amplifier 182 can rapidly activate the second low-side transistor N4 thereafter. Therefore, the current I_{VCM} can flow through the second low-side transistor N4 upon activation of the second low-side transistor N4. Accordingly, the arrow 302 demonstrates a current path for the current I_{VCM} flowing from ground, through the second low-side transistor N4 (i.e., initially through the diode 170 then through the second low-side transistor N4), through the VCM 158, through the first low-side transistor N3, to ground.

As an example, the amplifier 182 can be programmed to have a small negative offset voltage (e.g., −50 mV). Thus, upon the current I_{VCM} being completely discharged, the voltage V_{VCM}_{_{—}}_{B} and ground have a substantially equal voltage magnitude. Therefore, the analog output of the amplifier 182 decreases in magnitude in response to the voltage V_{VCM}_{_{—}}_{B} and ground having a substantially equal voltage magnitude, thus deactivating the second low-side transistor N4 based on the negative offset of the amplifier 182. In addition, the amplifier 182 provides a digital output signal PHASE_B to the retract velocity control stage 58, thus indicating to the retract velocity control stage 58 that the current I_{VCM} is substantially completely discharged. Accordingly, the retract velocity control stage 58 can switch to a BEMF measurement phase to sample the BEMF voltage V_{BEMF}, such as based on the state of the signals LOW_TH and HIGH_TH, as demonstrated in the examples of FIGS. 2 and 3.

FIG. 8 illustrates an example of a load short discharge phase 350 for the VCM output stage 156 in accordance with an aspect of the invention. Specifically, the load torque phase 350 demonstrates the state of the high and low-side transistors N1 through N4 to result in a direction of the current I_{VCM}, as demonstrated by an arrow 352, through the VCM 158.

In the example of FIG. 8, the switching signals HS_{A} and HS_{B} are demonstrated as having a logic-low state. As an example, the first high-side multi-state switch 172 is commanded to couple the gate of the first high-side transistor N1 to the node 160 based on the digital control signal CTRL_{HS}_{_{—}}_{A} and the second high-side multi-state switch 178 is commanded to couple the gate of the second high-side transistor N2 to the node 162 based on the digital control signal CTRL_{HS}_{_{—}}_{B}. Therefore, the first and second high-side transistors N1 and N2 are deactivated in the example of FIG. 8. Conversely, the switching signal LS_{B} is demonstrated as having a logic-high state. As an example, the second low-side multi-state switch 180 is commanded to couple the gate of the second low-side transistor N4 to ground based on the digital control signal CTRL_{LS}_{_{—}}_{B}. Therefore, the second low-side transistor N4 is activated in the example of FIG. 8. However, as indicated in the example of FIG. 8, the gate of the first low-side transistor N3 remains coupled to the output of the amplifier 176 based on the digital control signal CTRL_{LS}_{_{—}}_{A}. As described in greater detail below, the amplifier 176 can increase the analog magnitude of the switching signal LS_{A} at a transition from the load torque phase 250 to the load short discharge phase 350 to activate the first low-side transistor N3.

Based on the configuration of the first high and low-side transistors N1 and N3 as well as the second high and low-side transistors N2 and N4, the current I_{VCM} through the VCM 158 begins to discharge, such as from an immediately preceding load torque phase 250. Specifically, the inductive load of the VCM 158 maintains current flow subsequent to the load torque phase 250, such that the retract velocity control stage 58 commands the VCM output stage 156 to discharge the current I_{VCM} through the VCM 158 prior to measuring the BEMF voltage V_{BEMF}. Thus, during the load short discharge phase 350, the current I_{VCM} decreases as the VCM 158 discharges. Accordingly, the retract velocity control stage 58 maintains the load short discharge phase 350 until the current I_{VCM} is substantially completely discharged (i.e., having a magnitude of approximately zero) from the VCM 158.

As described above, the gate of the first low-side transistor N3 is coupled to the output of the amplifier 176 in the load torque phase 250 and remains coupled to the output of the amplifier 176 in the load short discharge phase 350. Referring back to the example of FIG. 4, the amplifier 176 is configured to monitor the magnitude of the voltage at the node 160 (e.g., the voltage V_{VCM}_{_{—}}_{A}) relative to ground. Initially, upon the transition from the load torque phase 250 to the load short discharge phase 350, the magnitude of the voltage V_{VCM}_{_{—}}_{A} rapidly decreases to a negative magnitude to maintain the current I_{VCM} through the VCM 158. The amplifier 176 thus tracks the magnitude of the voltage V_{VCM}_{_{—}}_{A} at its output, and thus provides the switching signal LS_{A} as having a magnitude approximately equal to the magnitude of the voltage V_{VCM}_{_{—}}_{A}. Initially, the current I_{VCM} flows from ground through the diode 168 based on an inherent delay in the bandwidth performance of the amplifier 176. However, because the analog magnitude of the switching signal LS_{A} was between 0 volts and a threshold voltage of the first low-side transistor N3 during the load torque phase 250, the amplifier 176 can rapidly activate the first low-side transistor N3 thereafter. Therefore, the current I_{VCM} can flow through the first low-side transistor N3 upon activation of the first low-side transistor N3. Accordingly, the arrow 352 demonstrates a current path for the current I_{VCM} flowing from ground, through the first low-side transistor N3 (i.e., initially through the diode 168 then through the first low-side transistor N3), through the VCM 158, through the second low-side transistor N4, to ground.

As an example, the amplifier 176 can be programmed to have a small negative offset voltage (e.g., −50 mV). Thus, upon the current I_{VCM} being completely discharged, the voltage V_{VCM}_{_{—}}_{A} and ground have a substantially equal voltage magnitude. Therefore, the output of the amplifier 176 decreases in response to the voltage V_{VCM}_{_{—}}_{A} and ground having a substantially equal voltage magnitude, thus deactivating the first low-side transistor N3 based on the negative offset of the amplifier 176. In addition, the amplifier 176 provides a digital output signal PHASE_A to the retract velocity control stage 58, thus indicating to the retract velocity control stage 58 that the current I_{VCM} is substantially completely discharged. Accordingly, the retract velocity control stage 58 can switch to a BEMF measurement phase to sample the BEMF voltage V_{BEMF}, such as based on the state of the signals LOW_TH and HIGH_TH, as demonstrated in the examples of FIGS. 2 and 3.

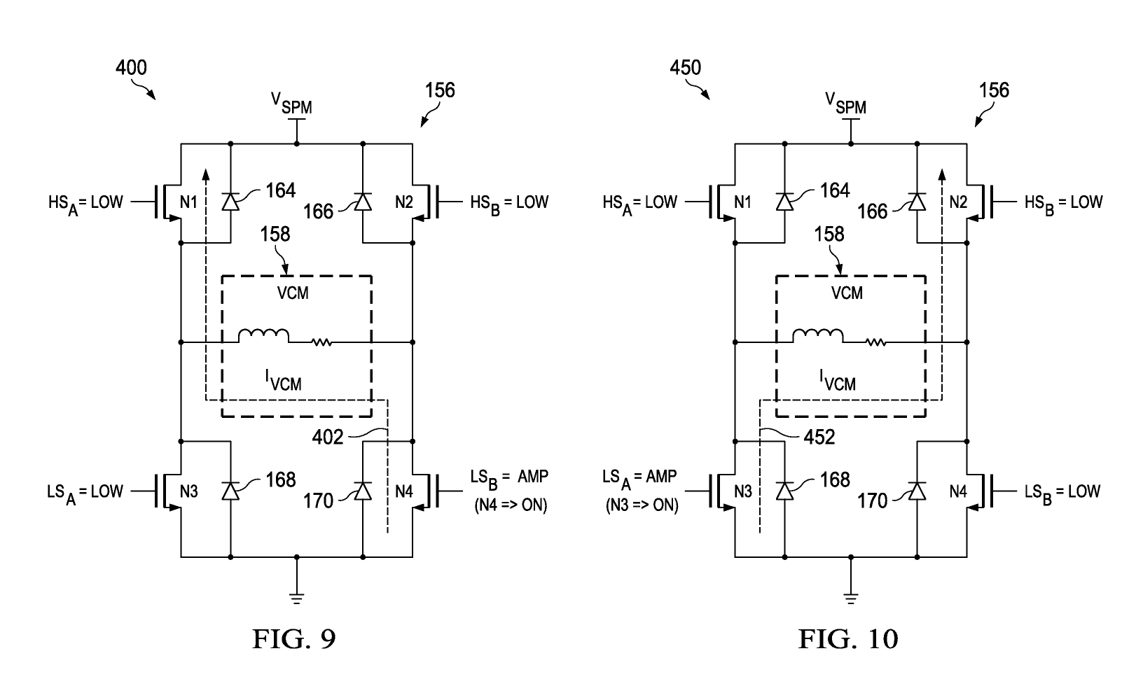

The examples of FIGS. 7 and 8 thus demonstrate one manner in which the current I_{VCM} can be substantially completely discharged from the VCM 158. Specifically, in the unload and load short discharge phases 300 and 350, both sides of the VCM 158 are shorted to ground to discharge the current I_{VCM}. In addition, by shorting both sides of the VCM 158 to ground, the slew-rate at which the current I_{VCM} is discharged is slower to mitigate mechanical acoustic noise associated with the VCM. However, the examples of FIGS. 9 and 10 demonstrates an alternative manner of discharging the current I_{VCM} from the VCM 158.

FIG. 9 illustrates an example of an unload high-impedance discharge phase 400 for the VCM output stage 156 in accordance with an aspect of the invention. Specifically, the unload high-impedance discharge phase 400 demonstrates the state of the high and low-side transistors N1 through N4 to result in a direction of the current I_{VCM}, as demonstrated by an arrow 402, through the VCM 158.

Similar to as described above in the example of FIG. 7, the current I_{VCM} is discharged from the VCM 158 in the unload high-impedance discharge phase 400, such as from an immediately preceding unload torque phase 200. Specifically, the retract velocity control stage 58 commands the VCM output stage 156 to discharge the current I_{VCM} through the VCM 158 prior to measuring the BEMF voltage V_{BEMF}. During the unload high-impedance discharge phase 400, the current I_{VCM} can decrease more rapidly than in the unload short discharge phase 300 in the example of FIG. 7. Accordingly, the retract velocity control stage 58 maintains the unload high-impedance discharge phase 400 until the current I_{VCM} is substantially completely discharged (i.e., having a magnitude of approximately zero) from the VCM 158.

In the example of FIG. 9, the switching signals HS_{A}, HS_{B}, and LS_{A} are demonstrated as having a logic-low state. As an example, the first high-side multi-state switch 172 is commanded to couple the gate of the first high-side transistor N1 to the node 160 based on the digital control signal CTRL_{HS}_{_{—}}_{A}, the second high-side multi-state switch 178 is commanded to couple the gate of the second high-side transistor N2 to the node 162 based on the digital control signal CTRL_{HS}_{_{—}}_{B}, and the first low-side multi-state switch 174 is commanded to couple the gate of the first low-side transistor N3 to ground based on the digital control signal CTRL_{LS}_{_{—}}_{A}. Therefore, the first and second high-side transistors N1 and N2, as well as the first low-side transistor N3, are deactivated in the example of FIG. 9. However, as indicated in the example of FIG. 9, the gate of the second low-side transistor N4 can remain coupled to the output of the amplifier 182 based on the digital control signal CTRL_{LS}_{_{—}}_{B}. Thus, similar to as described above in the example of FIG. 7, the amplifier 182 can increase the analog magnitude of the switching signal LS_{B} at a transition from the unload torque phase 200 to the unload high-impedance discharge phase 400 to activate the second low-side transistor N4.

Specifically, similar to as described above in the example of FIG. 7, upon the transition from the unload torque phase 200 to the unload high-impedance discharge phase 400, the magnitude of the voltage V_{VCM}_{_{—}}_{B} rapidly decreases to a negative magnitude to maintain the current I_{VCM} through the VCM 158. The amplifier 182 thus provides the switching signal LS_{B} as having a magnitude approximately equal to the magnitude of the voltage V_{VCM}_{_{—}}_{B}. Initially, the current I_{VCM} flows from ground through the diode 170 based on the inherent delay in the bandwidth performance of the amplifier 182. However, because the analog magnitude of the switching signal LS_{B} was between 0 volts and a threshold voltage of the second low-side transistor N4 during the unload torque phase 200, the amplifier 182 can rapidly activate the second low-side transistor N4 thereafter. Therefore, the current I_{VCM} can flow through the second low-side transistor N4 upon activation of the second low-side transistor N4. Accordingly, the arrow 402 demonstrates a current path for the current I_{VCM} flowing from ground, through the second low-side transistor N4 (i.e., initially through the diode 170 then through the second low-side transistor N4), through the VCM 158, through the diode 164, to the voltage V_{SPM}.

As described above, in the unload high-impedance discharge phase 400, the gate of the second low-side transistor N4 is coupled to the output of the amplifier 182. Thus, similar to as described above in the example of FIG. 7, upon the current I_{VCM} being completely discharged, the analog output of the amplifier 182 decreases in magnitude, thus deactivating the second low-side transistor N4 and asserting the digital output signal PHASE_B to the retract velocity control stage 58. Accordingly, the retract velocity control stage 58 is provided with an indication that the current I_{VCM} is substantially completely discharged. Accordingly, the retract velocity control stage 58 can switch to a BEMF measurement phase to sample the BEMF voltage V_{BEMF}, such as based on the state of the signals LOW_TH and HIGH_TH, as demonstrated in the examples of FIGS. 2 and 3.

FIG. 10 illustrates an example of a load high-impedance discharge phase 450 for the VCM output stage 156 in accordance with an aspect of the invention. Specifically, the load high-impedance discharge phase 450 demonstrates the state of the high and low-side transistors N1 through N4 to result in a direction of the current I_{VCM}, as demonstrated by an arrow 452, through the VCM 158.

Similar to as described above in the example of FIG. 8, the current I_{VCM} is discharged from the VCM 158 in the load high-impedance discharge phase 450, such as from an immediately preceding load torque phase 250. Specifically, the retract velocity control stage 58 commands the VCM output stage 156 to discharge the current I_{VCM} through the VCM 158 prior to measuring the BEMF voltage V_{BEMF}. During the load high-impedance discharge phase 450, the current I_{VCM} can decrease more rapidly than in the load short discharge phase 350 in the example of FIG. 8. Accordingly, the retract velocity control stage 58 maintains the unload high-impedance discharge phase 400 until the current I_{VCM} is substantially completely discharged (i.e., having a magnitude of approximately zero) from the VCM 158.

In the example of FIG. 10, the switching signals HS_{A}, HS_{B}, and LS_{B} are demonstrated as having a logic-low state. As an example, the first high-side multi-state switch 172 is commanded to couple the gate of the first high-side transistor N1 to the node 160 based on the digital control signal CTRL_{HS}_{_{—}}_{A}, the second high-side multi-state switch 178 is commanded to couple the gate of the second high-side transistor N2 to the node 162 based on the digital control signal CTRL_{HS}_{_{—}}_{B}, and the second low-side multi-state switch 180 is commanded to couple the gate of the second low-side transistor N4 to ground based on the digital control signal CTRL_{LS}_{_{—}}_{B}. Therefore, the first and second high-side transistors N1 and N2, as well as the second low-side transistor N4, are deactivated in the example of FIG. 10. However, as indicated in the example of FIG. 10, the gate of the first low-side transistor N3 can remain coupled to the output of the amplifier 176 based on the digital control signal CTRL_{LS}_{_{—}}_{A}. Thus, similar to as described above in the example of FIG. 8, the amplifier 176 can increase the analog magnitude of the switching signal LS_{A} at a transition from the load torque phase 250 to the load high-impedance discharge phase 450 to activate the second low-side transistor N3.

Specifically, similar to as described above in the example of FIG. 8, upon the transition from the load torque phase 250 to the load high-impedance discharge phase 450, the magnitude of the voltage V_{VCM}_{_{—}}_{A} rapidly decreases to a negative magnitude to maintain the current I_{VCM} through the VCM 158. The amplifier 176 thus provides the switching signal LS_{A} as having a magnitude approximately equal to the magnitude of the voltage V_{VCM}_{_{—}}_{A}. Initially, the current I_{VCM} flows from ground through the diode 168 based on the inherent delay in the bandwidth performance of the amplifier 176. However, because the analog magnitude of the switching signal LS_{A} was between 0 volts and a threshold voltage of the first low-side transistor N3 during the load torque phase 250, the amplifier 176 can rapidly activate the first low-side transistor N3 thereafter. Therefore, the current I_{VCM} can flow through the first low-side transistor N3 upon activation of the first low-side transistor N3. Accordingly, the arrow 452 demonstrates a current path for the current I_{VCM} flowing from ground, through the first low-side transistor N3 (i.e., initially through the diode 168 then through the first low-side transistor N3), through the VCM 158, through the diode 170, to the voltage V_{SPM}.

As described above, in the load high-impedance discharge phase 450, the gate of the first low-side transistor N3 is coupled to the output of the amplifier 176. Thus, similar to as described above in the example of FIG. 8, upon the current I_{VCM} being completely discharged, the analog output of the amplifier 176 decreases in magnitude, thus deactivating the first low-side transistor N3 and asserting the digital output signal PHASE_A to the retract velocity control stage 58. Accordingly, the retract velocity control stage 58 is provided with an indication that the current I_{VCM} is substantially completely discharged. Accordingly, the retract velocity control stage 58 can switch to a BEMF measurement phase to sample the BEMF voltage V_{BEMF}, such as based on the state of the signals LOW_TH and HIGH_TH, as demonstrated in the examples of FIGS. 2 and 3.

The examples of FIGS. 9 and 10 thus demonstrate another manner in which the current I_{VCM} can be substantially completely discharged from the VCM 158. Specifically, in the unload and load high-impedance discharge phases 400 and 450, the current I_{VCM} is forced to flow from the low voltage power rail, through the VCM 158, to the high voltage power rail. Thus, in the unload and load high-impedance discharge phases 400 and 450, the current I_{VCM} discharges at a more rapid slew-rate.

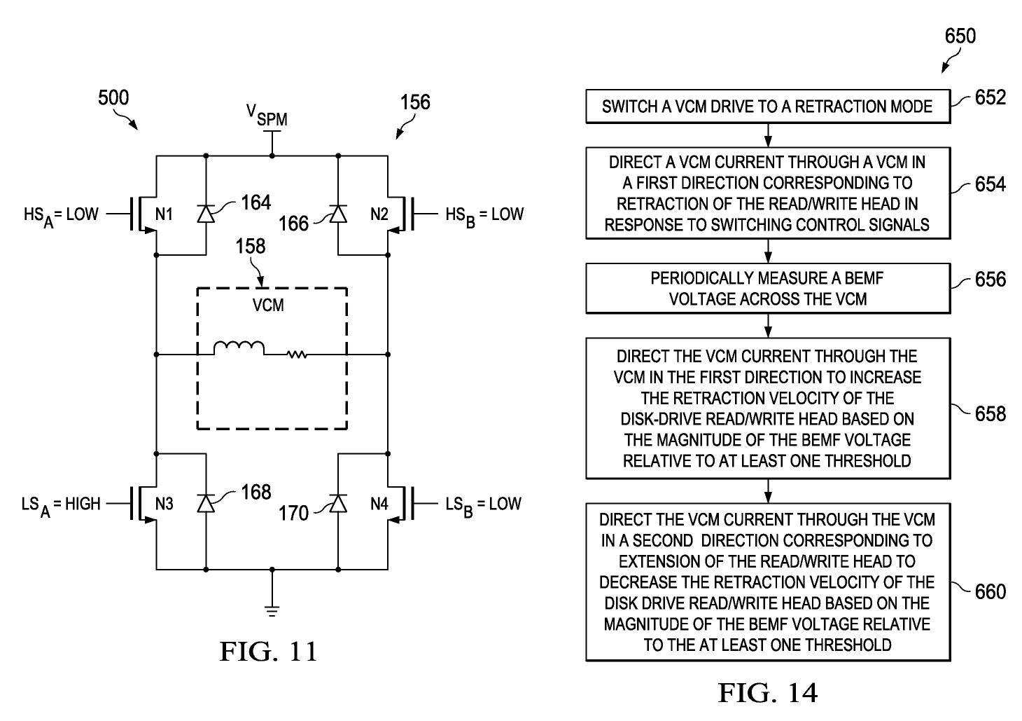

FIG. 11 illustrates an example of a BEMF measurement phase 500 for a VCM output stage in accordance with an aspect of the invention. The BEMF measurement phase 500 can immediately proceed any of the unload or load short or high-impedance phases 300, 350, 400, or 450, respectively, as described above in the examples of FIGS. 7-10. Therefore, during the BEMF measurement phase 500, the current I_{VCM} has a magnitude that is approximately zero, such that the current I_{VCM} has been substantially completely discharged from the VCM 158.

In the example of FIG. 11, the switching signals HS_{A}, HS_{B}, and LS_{B} are demonstrated as having a logic-low state. As an example, the first high-side multi-state switch 172 is commanded to couple the gate of the first high-side transistor N1 to the node 160 based on the digital control signal CTRL_{HS}_{_{—}}_{A}, the second high-side multi-state switch 178 is commanded to couple the gate of the second high-side transistor N2 to the node 162 based on the digital control signal CTRL_{HS}_{_{—}}_{B}, and the second low-side multi-state switch 180 is commanded to couple the gate of the second low-side transistor N4 to ground based on the digital control signal CTRL_{LS}_{_{—}}_{B}. Therefore, the first and second high-side transistors N1 and N2, as well as the second low-side transistor N4, are deactivated in the example of FIG. 11. However, the switching signal LS_{A} is demonstrated as having a logic-high state, such as based on the first low-side multi-state switch 174 coupling the gate of the first low-side transistor N3 to the node 160 based on the digital control signal CTRL_{LS}_{_{—}}_{A}. Thus, the first low-side transistor N3 is activated in the example of FIG. 11.

Based on the configuration of the first high and low-side transistors N1 and N3 as well as the second high and low-side transistors N2 and N4, the VCM output stage 156 is arranged such that the voltage V_{VCM}_{_{—}}_{B} is referenced to the low voltage power rail. As a result, the high and low threshold voltages V_{HIGH}_{_{—}}_{TH} and V_{LOW}_{_{—}}_{TH} are referenced to the low voltage power rail, such as demonstrated in the example of FIG. 3, such that the voltage V_{VCM}_{_{—}}_{A} can be compared with the high and low threshold voltages V_{HIGH}_{_{—}}_{TH} and V_{LOW}_{_{—}}_{TH} with the same voltage reference. Accordingly, the magnitude of the BEMF voltage V_{BEMF} is accurately compared with the high and low threshold voltages V_{HIGH}_{_{—}}_{TH} and V_{LOW}_{_{—}}_{TH}.

As an example, the retract velocity control stage 58 can be configured to switch the VCM output stage 156 to the BEMF measurement phase 500 in response to one of the signals PHASE_A or PHASE_B. As another example, the VCM output stage 156 can automatically be switched to the BEMF measurement phase 500 based on the change in logic-state of the amplifier 182, such as at the conclusion of the unload short discharge phase 300 in the example of FIG. 7. As yet another example, similar to as described above in the example of FIG. 3, the state of the first and second low-side transistors N3 and N4 can be reversed in the BEMF measurement phase 500, such as based on the radial direction of movement that corresponds to retraction of the read/write head.

Furthermore, it is to be understood that the retract control velocity stage 58 is configured to sample the BEMF voltage V_{BEMF} based on a sample time. In other words, upon arranging the first and second high and low-side switches N1 through N4, as described above, the BEMF voltage V_{BEMF} can be sampled subsequently, such as upon any transient effects settling. For example, the VCM BEMF measurement stage 64 can await a clock input or other input signal before sampling the BEMF voltage V_{BEMF}. As another example, the retract velocity control stage 58 can set a predetermined duration of time that is shared between the respective one of the unload or load discharge phases 300, 350, 400, or 450 and the BEMF measurement phase 500. Accordingly, the BEMF measurement phase 500 has an associated sampling time for measuring the BEMF voltage V_{BEMF}.

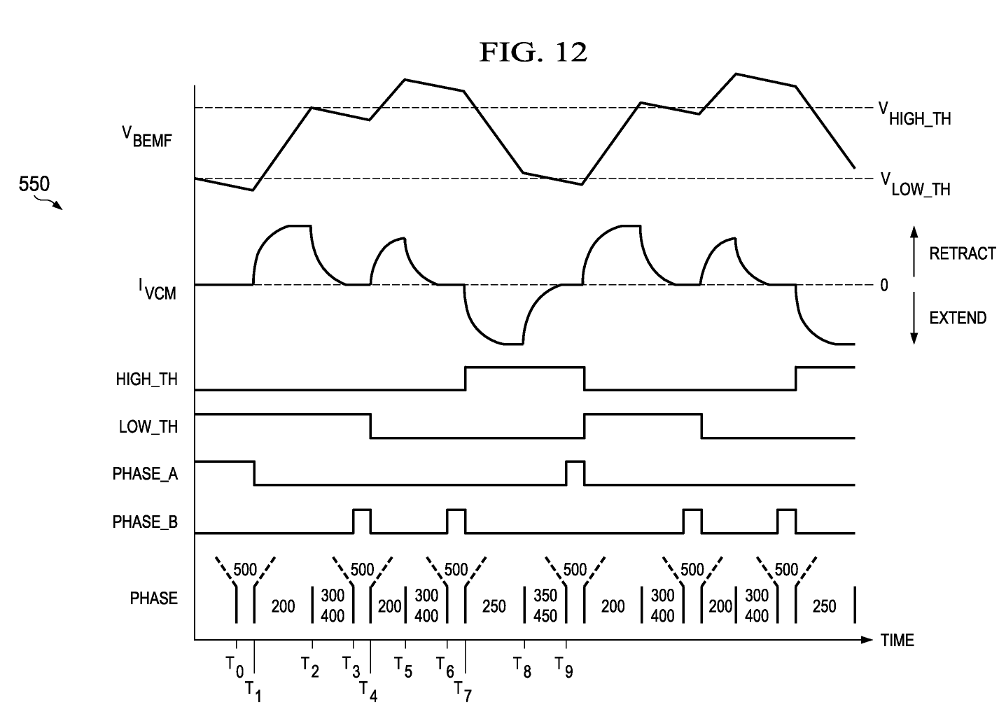

FIG. 12 illustrates an example of a timing diagram 550 of a VCM switching stage in accordance with an aspect of the invention. The timing diagram 550 can correspond to the VCM switching stage 150 in the example of FIG. 4. Therefore, reference is to be made to examples of FIGS. 2-11 in the following description of the example of FIG. 12.

The timing diagram 550 demonstrates the magnitude of the BEMF voltage V_{BEMF} relative to the high and low threshold voltages V_{HIGH}_{_{—}}_{TH} and V_{LOW}_{_{—}}_{TH} as a function of time. The timing diagram 550 also demonstrates the current I_{VCM} through the VCM 158 relative to a magnitude zero, such as upon the current I_{VCM} being substantially completely discharged, as a function of time. In addition, the timing diagram demonstrates the signals HIGH_TH, LOW_TH, PHASE_A, and PHASE_B as a function of time. Furthermore, the timing diagram 550 demonstrates the phase in which the retract velocity control stage 58 operates at a given time.

In the example of FIG. 12, the BEMF voltage V_{BEMF} is demonstrated as slowly decreasing at a magnitude that is less than the low threshold voltage V_{LOW}_{_{—}}_{TH}. The current I_{VCM} through the VCM 158 is demonstrated as having a magnitude of approximately zero, thus the signal PHASE_A is asserted, such as based on being provided by the amplifier 176. At a time To, the retract velocity control stage 58 switches to the BEMF measurement phase 500. Therefore, at the time T₀, the retract velocity control stage 58 initiates a BEMF measurement phase 500.

At a time T₁, subsequent to the sampling time of the BEMF measurement phase 500, the VCM BEMF measurement stage 64 determines that the BEMF voltage V_{BEMF} is less than the low threshold voltage V_{LOW}_{_{—}}_{TH}, and asserts the signal LOW_TH. Thus, the retract velocity control stage 58 samples the BEMF voltage V_{BEMF} by receiving the signal LOW_TH that indicates that the BEMF voltage V_{BEMF} is less than the low threshold voltage V_{LOW}_{_{—}}_{TH}. The retract velocity control stage 58 responds by switching to the unload torque phase 200 to increase the speed of retraction of the read/write head. Thus, the retract velocity control stage 58 commands the VCM output stage 156 to provide the current I_{VCM} in the retraction direction through the VCM 158, such as demonstrated in the example of FIG. 5. Accordingly, the BEMF voltage V_{BEMF} increases subsequent to the time T₁. The retract velocity control stage 58 can remain in the unload torque phase 200 for a first predetermined duration of time (i.e., from the time T₁ to a time T₂). At the time T₂, the retract velocity control stage 58 concludes the unload torque phase 200 and switches to the unload short discharge phase 300 or the unload high-impedance discharge phase 400. Therefore, the retract velocity control stage 58 commands the VCM output stage 156 to discharge the current I_{VCM}. Thus, the current I_{VCM} is demonstrated as decreasing subsequent to the time T₂.

At a time T₃, the current I_{VCM} is substantially completely discharged. Therefore, the signal PHASE_B is asserted, such as based on being provided by the amplifier 182 in response to monitoring the voltage V_{VCM}_{_{—}}_{B} relative to ground. Accordingly, the retract velocity control stage 58 initiates a BEMF measurement phase 500.

At a time T₄, the VCM BEMF measurement stage 64 determines that the BEMF voltage V_{BEMF} is between the high and low threshold voltages V_{HIGH}_{_{—}}_{TH} and V_{LOW}_{_{—}}_{TH}, and de-asserts the signal LOW_TH. Thus, the retract velocity control stage 58 samples the BEMF voltage V_{BEMF} by monitoring the states of the signals HIGH_TH and LOW_TH that indicate that the BEMF voltage V_{BEMF} is between the high and low threshold voltages V_{HIGH}_{_{—}}_{TH} and V_{LOW}_{_{—}}_{TH}. In the example of FIG. 12, the signals HIGH_TH and LOW_TH can be clocked by a latch or other type of circuit, such that they change states at the end of the sampling of the BEMF voltage V_{BEMF}.

The retract velocity control stage 58 responds by switching to the unload torque phase 200 to increase the speed of retraction of the read/write head. Thus, the retract velocity control stage 58 again commands the VCM output stage 156 to provide the current I_{VCM} in the retraction direction through the VCM 158. Accordingly, the BEMF voltage V_{BEMF} increases subsequent to the time T₄. However, because the BEMF voltage V_{BEMF} is between the high and low threshold voltages V_{HIGH}_{_{—}}_{TH} and V_{LOW}_{_{—}}_{TH} instead of less than the low threshold voltage V_{LOW}_{_{—}}_{TH}, the retract velocity control stage 58 unloads less torque than at the time T₁, and thus remains in the unload torque phase 200 for a second predetermined duration of time that is less than the duration from the time T₁ to the time T₂. At the time T₅, the retract velocity control stage 58 concludes the unload torque phase 200 and again switches to the unload short discharge phase 300 or the unload high-impedance discharge phase 400 to discharge the current I_{VCM}. Thus, the current I_{VCM} is demonstrated as decreasing subsequent to the time T₅.

At a time T₆, the current I_{VCM} is substantially completely discharged. Therefore, the signal PHASE_B is asserted, such as based on being provided by the amplifier 182 in response to monitoring the voltage V_{VCM}_{_{—}}_{B} relative to ground. Accordingly, the retract velocity control stage 58 initiates a BEMF measurement phase 500 at the time T₆. At a time T₇, the VCM BEMF measurement stage 64 determines that the BEMF voltage V_{BEMF} is greater than the high threshold voltage V_{HIGH}_{_{—}}_{TH}, and thus asserts the signal HIGH_TH. Thus, the retract velocity control stage 58 samples the BEMF voltage V_{BEMF} by receiving the signal HIGH_TH that indicates that the BEMF voltage V_{BEMF} is greater than the high threshold voltage V_{HIGH}_{_{—}}_{TH}.

The retract velocity control stage 58 responds by switching to the load torque phase 250 to decrease the speed of retraction of the read/write head. Thus, the retract velocity control stage 58 commands the VCM output stage 156 to provide the current I_{VCM} in the extension direction through the VCM 158, and thus opposite the retraction direction. Accordingly, the BEMF voltage V_{BEMF} decreases subsequent to the time T₇. The retract velocity control stage 58 can remain in the load torque phase 250 for a predetermined duration of time, such as the same as the unload torque phase 200 occurring between the times T₁ and T₂. At the time T₈, the retract velocity control stage 58 concludes the load torque phase 250 and switches to the load short discharge phase 350 or the load high-impedance discharge phase 450 to discharge the current I_{VCM}. Thus, the current I_{VCM} is demonstrated as decreasing in the extension direction subsequent to the time T₈.

At a time T₉, the timing diagram 550 substantially repeats the phases beginning at the time T₀ based on the magnitude of the BEMF voltage V_{BEMF} relative to the high and low threshold voltages V_{HIGH}_{_{—}}_{TH} and V_{LOW}_{_{—}}_{TH}. Therefore, the timing diagram 550 demonstrates one manner in which the retract controller 54 in the example of FIG. 2 can efficiently control the retract velocity of the read/write head of a magnetic disk-drive system.

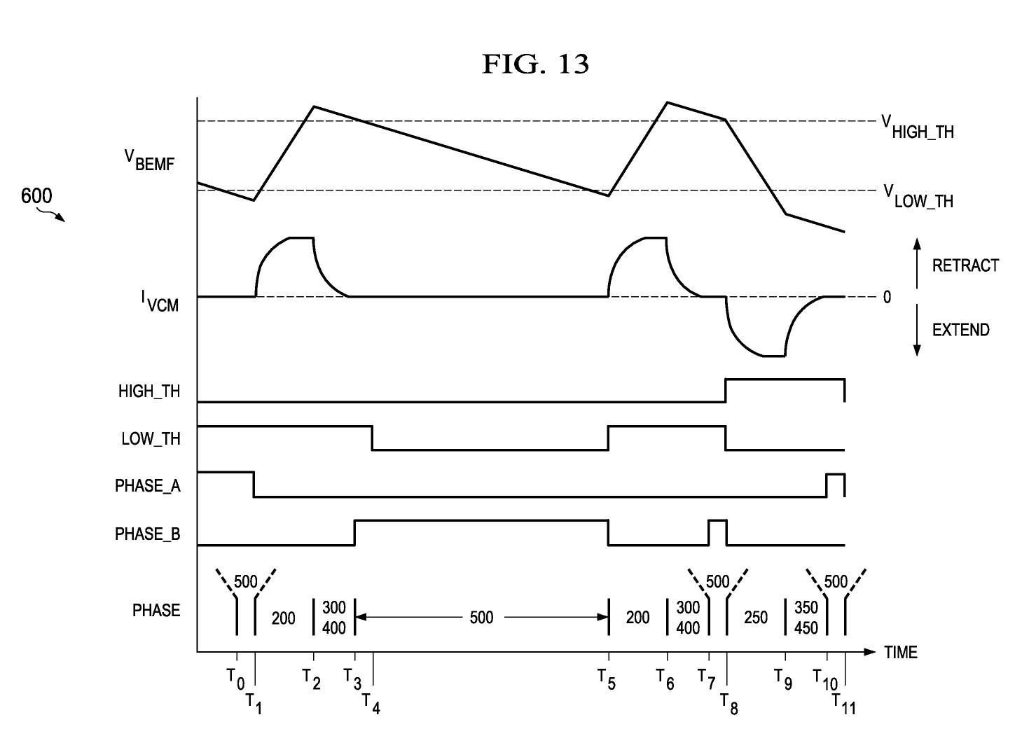

FIG. 13 illustrates another example of a timing diagram 600 of a VCM switching stage in accordance with an aspect of the invention. The timing diagram 600 can likewise correspond to the VCM switching stage 150 in the example of FIG. 4. Therefore, reference is to be made to examples of FIGS. 2-11 in the following description of the example of FIG. 13.

Similar to the timing diagram 550 in the example of FIG. 12, the timing diagram 600 demonstrates the magnitude of the BEMF voltage V_{BEMF} relative to the high and low threshold voltages V_{HIGH}_{_{—}}_{TH} and V_{LOW}_{_{—}}_{TH} as a function of time. The timing diagram 600 also demonstrates the current I_{VCM} through the VCM 158 relative to a magnitude zero, such as upon the current I_{VCM} being substantially completely discharged, as a function of time. In addition, the timing diagram demonstrates the signals HIGH_TH, LOW_TH, PHASE_A, and PHASE_B as a function of time. Furthermore, the timing diagram 600 demonstrates the phase in which the retract velocity control stage 58 operates at a given time.

In the example of FIG. 13, the BEMF voltage V_{BEMF} is demonstrated as slowly decreasing at a magnitude that is less than the low threshold voltage V_{LOW}_{_{—}}_{TH} The current I_{VCM} through the VCM 158 is demonstrated as having a magnitude of approximately zero, thus the signal PHASE_A is asserted, such as based on being provided by the amplifier 176. At a time T₀, the retract velocity control stage 58 switches to the BEMF measurement phase 500. Therefore, at a time T₁, the VCM BEMF measurement stage 64 determines that the BEMF voltage V_{BEMF} is less than the low threshold voltage V_{LOW}_{_{—}}_{TH}, and asserts the signal LOW_TH. Thus, the retract velocity control stage 58 samples the BEMF voltage V_{BEMF} by receiving the signal LOW_TH that indicates that the BEMF voltage V_{BEMF} is less than the low threshold voltage V_{LOW}_{_{—}}_{TH}.

The retract velocity control stage 58 responds by switching to the unload torque phase 200 to increase the speed of retraction of the read/write head. Thus, the retract velocity control stage 58 commands the VCM output stage 156 to provide the current I_{VCM} in the retraction direction through the VCM 158, such as demonstrated in the example of FIG. 5. Accordingly, the BEMF voltage V_{BEMF} increases subsequent to the time T₁. The retract velocity control stage 58 can remain in the unload torque phase 200 for a first predetermined duration of time (i.e., from the time T₁ to a time T₂). At the time T₂, the retract velocity control stage 58 concludes the unload torque phase 200 and switches to the unload short discharge phase 300 or the unload high-impedance discharge phase 400. Therefore, the retract velocity control stage 58 commands the VCM output stage 156 to discharge the current I_{VCM}. Thus, the current I_{VCM} is demonstrated as decreasing subsequent to the time T₂.

At a time T₃, the current I_{VCM} is substantially completely discharged. Therefore, the signal PHASE_B is asserted, such as based on being provided by the amplifier 182 in response to monitoring the voltage V_{VCM}_{_{—}}_{B} relative to ground. Accordingly, the retract velocity control stage 58 initiates a BEMF measurement phase 500. At a time T₄, a sampling time of the VCM BEMF measurement stage 64 concludes. The VCM BEMF measurement stage 64 thus determines that the BEMF voltage V_{BEMF} is between the high and low threshold voltages V_{HIGH}_{_{—}}_{TH} and V_{LOW}_{_{—}}_{TH}, and de-asserts the signal LOW_TH. Thus, the retract velocity control stage 58 samples the BEMF voltage V_{BEMF} by monitoring the lack of both of the signals HIGH_TH and LOW_TH that indicate that the BEMF voltage V_{BEMF} is between the high and low threshold voltages V_{HIGH}_{_{—}}_{TH} and V_{LOW}_{_{—}}_{TH}.

In the example of FIG. 13, the retract velocity control stage 58 can be configured to remain in the BEMF measurement phase 500 in response to the BEMF voltage V_{BEMF} having a magnitude that is between the high and low threshold voltages V_{HIGH}_{_{—}}_{TH} and V_{LOW}_{_{—}}_{TH}. As such, the read/write head can “coast” in the retraction direction while the BEMF voltage V_{BEMF} has a magnitude that is between the high and low threshold voltages V_{HIGH}_{_{—}}_{TH} and V_{LOW}_{_{—}}_{TH}.

For example, the retract velocity control stage 58 could be programmed to switch to the unload torque phase 200 for a first predetermined duration upon the BEMF voltage V_{BEMF} having a magnitude that is less than the low threshold voltage V_{LOW}_{_{—}}_{TH} and for a second predetermined duration upon the BEMF voltage V_{BEMF} having a magnitude that is between the high and low threshold voltages V_{HIGH}_{_{—}}_{TH} and V_{LOW}_{_{—}}_{TH}. Thus, in the example of FIG. 13, the retract velocity control stage 58 could be programmed to set the second predetermined duration to zero, such that the retract velocity control stage 58 does not switch to unload torque phase 200 in response to the BEMF voltage V_{BEMF} having a magnitude that is between the high and low threshold voltages V_{HIGH}_{_{—}}_{TH} and V_{LOW}_{_{—}}_{TH}. Therefore, as an example, the retract velocity control stage 58 can be configured to continuously monitor the signal LOW_TH subsequent to the time T₃ until it is asserted. As another example, the retract velocity control stage 58 can periodically monitor the signal LOW_TH subsequent to the time T₄, such as once at every predetermined interval of time. Accordingly, from the time T₄ to a time T₅, the current I_{VCM} remains at approximately zero.

At the time T₅, at the end a sampling time of a BEMF measurement phase 500, the VCM BEMF measurement stage 64 determines that the BEMF voltage V_{BEMF} has decreased in magnitude less than the low threshold voltage V_{LOW}_{_{—}}_{TH}. Therefore, at the time T₅, the VCM BEMF measurement stage 64 determines that the BEMF voltage V_{BEMF} is less than the low threshold voltage V_{LOW}_{_{—}}_{TH}, and asserts the signal LOW_TH. Thus, the retract velocity control stage 58 the BEMF voltage V_{BEMF} receives the signal LOW_TH that indicates that the BEMF voltage V_{BEMF} is less than the low threshold voltage V_{LOW}_{_{—}}_{TH}.

At the time T₅, the retract velocity control stage 58 responds by switching to the unload torque phase 200 to increase the speed of retraction of the read/write head. Thus, the retract velocity control stage 58 again commands the VCM output stage 156 to provide the current I_{VCM} in the retraction direction through the VCM 158. Accordingly, the BEMF voltage V_{BEMF} increases subsequent to the time T₅. The retract velocity control stage 58 can remain in the unload torque phase 200 for same predetermined duration of time (i.e., such as from the time T₁ to a time T₂). At a time T₆, the retract velocity control stage 58 concludes the unload torque phase 200 and again switches to the unload short discharge phase 300 or the unload high-impedance discharge phase 400. Therefore, the retract velocity control stage 58 commands the VCM output stage 156 to discharge the current I_{VCM}.

At a time T₇, the current I_{VCM} is substantially completely discharged. Therefore, the signal PHASE_B is asserted, such as based on being provided by the amplifier 182 in response to monitoring the voltage V_{VCM}_{_{—}}_{B} relative to ground, to initiate a BEMF measurement phase 500. At a time T₈, the VCM BEMF measurement stage 64 determines that the BEMF voltage V_{BEMF} is greater than the high threshold voltage V_{HIGH}_{_{—}}_{TH}, and thus asserts the signal HIGH_TH. Thus, the retract velocity control stage 58 samples the BEMF voltage V_{BEMF} by receiving the signal HIGH_TH that indicate that the BEMF voltage V_{BEMF} is greater than the high threshold voltage V_{HIGH}_{_{—}}_{TH}.

The retract velocity control stage 58 responds by switching to the load torque phase 250 to decrease the speed of retraction of the read/write head. Thus, the retract velocity control stage 58 commands the VCM output stage 156 to provide the current I_{VCM} in the extension direction through the VCM 158, and thus opposite the retraction direction. Accordingly, the BEMF voltage V_{BEMF} decreases subsequent to the time T₈. The retract velocity control stage 58 can remain in the load torque phase 250 for a predetermined duration of time, such as the same as the unload torque phase 200 occurring between the times T₁ and T₂ and between the times T₅ and T₆. At a time T₉, the retract velocity control stage 58 concludes the load torque phase 250 and switches to the load short discharge phase 350 or the load high-impedance discharge phase 450 to discharge the current I_{VCM}. Thus, the current I_{VCM} is demonstrated as decreasing in the extension direction subsequent to the time T₉.

At a time T₁₀, the current I_{VCM} is substantially completely discharged. Therefore, the signal PHASE_B is asserted, such as based on being provided by the amplifier 182 in response to monitoring the voltage V_{VCM}_{_{—}}_{B} relative to ground to initiate another BEMF measurement phase 500. Accordingly, at a time T₁₁, the VCM BEMF measurement stage 64 determines that the BEMF voltage V_{BEMF} is again less than the low threshold voltage V_{LOW}_{_{—}}_{TH}, and asserts the signal LOW_TH. Thus, the retract velocity control stage 58 samples the BEMF voltage V_{BEMF} by receiving the signal and LOW_TH that indicate that the BEMF voltage V_{BEMF} is less than the low threshold voltage V_{LOW}_{_{—}}_{TH}. Accordingly, at the time T₁₁, the retract velocity control stage 58 can again switch to the unload torque phase 200.

In view of the foregoing structural and functional features described above, certain methods will be better appreciated with reference to FIG. 14. It is to be understood and appreciated that the illustrated actions, in other embodiments, may occur in different orders and/or concurrently with other actions. Moreover, not all illustrated features may be required to implement a method.

FIG. 14 illustrates an example of a method 650 for controlling a retraction velocity of a disk-drive read/write head in accordance with an aspect of the invention. At 652, a VCM drive is switched to a retraction mode. As an example, the disk-drive system can switch to the retraction mode based on a power loss associated with a power supply that provides power to both a VCM drive and an SPM drive. Thus, the retraction mode can be a mode that commands the magnetic disk read/write head to move to a neutral or inactive location. The SPM drive can provide power to the VCM drive based on a rectified BEMF of the SPM motor.

At 654, a VCM current is directed through a VCM in a first direction corresponding to retraction of the read/write head in response to switching control signals. The read/write head is thus initially moved in the retraction direction based on the current flow through the VCM in the first direction. At 656, a BEMF voltage is periodically measured across the VCM. The periodic measurement can be subsequent to substantially completely discharging the VCM current through the VCM to obtain an accurate measurement of the BEMF voltage. The discharging of the current through the VCM can vary based on VCM characteristics, based on the desired speed of discharge relative to an amount of mechanical acoustic noise of the VCM, and based on the direction of current flow through the VCM prior to the discharge. The measurement of the BEMF voltage can be based on comparing the BEMF voltage to at least one threshold that can be programmably set.

At 658, the VCM current is directed through the VCM in the first direction to increase the retraction velocity of the disk-drive read/write head based on a magnitude of the BEMF voltage relative to at least one threshold. As an example, the VCM current can be directed through the VCM in the first direction based on the BEMF voltage being less than a low threshold voltage, such as for a first predetermined duration. As another example, the VCM current can be directed through the VCM in the first direction based on the BEMF voltage being between a high threshold voltage and a low threshold voltage, such as for a second predetermined duration that is less than the first predetermined duration. As yet another example, the second predetermined duration can be zero, such that the read/write head is allowed to coast in response to the BEMF voltage being between the high and low threshold voltages. At 660, the VCM current is directed through the VCM in a second direction corresponding to extension of the read/write head to decrease the retraction velocity of the disk-drive read/write head based on the magnitude of the BEMF voltage relative to the at least one threshold. As an example, the VCM current can be directed through the VCM in the second direction based on the BEMF voltage being greater than a high threshold voltage, such as for the same first predetermined duration. Therefore, the velocity of the retraction of the read/write head can be efficiently controlled to avoid damage to the magnetic disk and to the read/write head itself.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A voice coil motor (VCM) drive system comprising:
a VCM configured to move a disk-drive read/write head across a magnetic disk in response to a VCM current flow through the VCM;
a VCM output stage configured to direct the VCM current through the VCM in one of a first direction corresponding to retraction of the read/write head and a second direction corresponding to extension of the read/write head in response to switching control signals; and
a retract controller configured to control a retraction velocity of the disk-drive read/write head by generating the switching control signals to provide the VCM current in the first direction to increase the retraction velocity of the read/write head and to provide the VCM current in the second direction to decrease the retraction velocity of the read/write head during a retraction mode of the VCM drive system.

2. The system of claim 1, wherein the retract controller comprises a measurement stage configured to measure a back-electromotive force (BEMF) voltage across the VCM, the switching control signals being generated in response to the measured BEMF voltage relative to at least one threshold.

3. The system of claim 2, wherein the measurement stage comprises a programmable threshold selector configured to set a first threshold corresponding to a maximum desired retraction velocity of the read/write head and a second threshold corresponding to a minimum desired retraction velocity of the read/write head in response to a digital threshold selection signal.

4. The system of claim 3, wherein the programmable threshold selector comprises a first resistive ladder circuit configured to set the first threshold and a second resistive ladder circuit configured to set the second threshold, each of the first and second resistive ladder circuits comprising a plurality of switches that are controlled by the digital threshold selection signal to set a variable resistance that corresponds to the respective first and second thresholds.

5. The system of claim 3, wherein the retract controller is configured to provide the VCM current through the VCM in the first direction for a first duration in response to the measured BEMF voltage being less than the second threshold, to provide the VCM current through the VCM in the second direction for the first duration in response to the measured BEMF voltage being greater than the first threshold, and to provide the VCM current through the VCM in the first direction for a second duration in response to the measured BEMF voltage being between the first and second thresholds, the second duration being less than the first duration.

6. The system of claim 5, wherein the second duration is approximately zero such that the measurement stage periodically samples the BEMF across the VCM until the measured BEMF is one of greater than the first threshold and less than the second threshold.

7. The system of claim 1, wherein the VCM output stage comprises at least one high-side switch and at least one low-side switch that are coupled to the VCM and configured to direct the VCM current through the VCM, and wherein the retract controller comprises:
a retract velocity control stage configured to generate the switching control signals in response to a sampled back-electromotive force (BEMF) voltage across the VCM; and
a retract switch control stage configured to selectively activate the at least one high-side switch and the at least one low-side switch in response to the switching control signals.

8. The system of claim 7, wherein the retract velocity control stage is further configured to set the switching control signals to periodically discharge the VCM current through the VCM during a discharge phase to allow the retract controller to subsequently sample the BEMF voltage across the VCM.

9. The system of claim 8, wherein the at least one low-side switch comprises a pair of low-side switches coupled between a low voltage power rail and opposite ends of the VCM, respectively, the retract velocity control stage setting the switching control signals to activate the pair of low-side switches to short the opposite ends of the VCM to the low voltage power rail during the discharge phase.

10. The system of claim 8, wherein the VCM output stage is configured between a high voltage power rail and a low voltage power rail, wherein each of the at least one high-side switch and the at least one low-side switch comprises a parallel-coupled diode, and wherein the retract velocity control stage sets the switching control signals to deactivate the at least one high-side switch and the at least one low-side switch to provide a current path for the VCM current from the low voltage power rail through the VCM to the high voltage power rail during the discharge phase.

11. The system of claim 8, wherein the retract switch control stage comprises at least one amplifier having an output that is coupled to the at least one low-side switch in response to the switching control signals and having inputs coupled to a low voltage power rail and the VCM, respectively, the amplifier activating the at least one low-side switch and providing a digital output to the retract velocity control stage in response to detecting approximately zero current through the VCM to automatically switch the retract velocity control stage to a BEMF measurement phase.

12. A method for controlling a retraction velocity of a disk-drive read/write head, the method comprising:
switching a voice coil motor (VCM) drive to a retraction mode;
directing a VCM current through a VCM in a first direction corresponding to retraction of the disk-drive read/write head in response to switching control signals;
periodically measuring a back-electromotive force (BEMF) voltage across the VCM;
directing the VCM current through the VCM in the first direction to increase the retraction velocity of the disk-drive read/write head based on a magnitude of the BEMF voltage relative to at least one threshold; and
directing the VCM current through the VCM in a second direction corresponding to extension of the disk-drive read/write head to decrease the retraction velocity of the disk-drive read/write head based on the magnitude of the BEMF voltage relative to the at least one threshold.

13. The method of claim 12, further comprising setting the at least one threshold as a first threshold corresponding to a maximum desired retraction velocity of the read/write head and a second threshold corresponding to a minimum desired retraction velocity of the read/write head in response to a digital threshold selection signal, the first threshold being greater than the second threshold.

14. The method of claim 13, wherein setting the first and second thresholds comprises:
closing at least one switch of a first resistive ladder circuit in response to the digital threshold selection signal to set a variable resistance that corresponds to the first threshold; and
closing at least one switch of a second resistive ladder circuit in response to the digital threshold selection signal to set a variable resistance that corresponds to the second threshold.

15. The method of claim 13, directing the VCM current through the VCM comprises:
directing the VCM current through the VCM in the first direction in response to the BEMF voltage across the VCM being less than the second threshold; and
directing the VCM current through the VCM in the second direction in response to the measured BEMF voltage being greater than the first threshold.

16. The method of claim 12, wherein periodically measuring the BEMF voltage across the VCM comprises discharging the VCM current from the VCM based on one of shorting the VCM to a low voltage power rail and conducting the VCM current from the low voltage power rail to a high voltage power rail in response to the switching control signals.

17. The method of claim 16, wherein discharging the VCM current comprises:
monitoring a voltage associated with the VCM relative to a voltage associated with the low voltage power rail;
activating a low-side switch that is coupled to the VCM in response to the voltage associated with the VCM becoming greater than the voltage associated with the low voltage power rail; and
providing a digital signal to a controller prompting the controller to measure the BEMF voltage across the VCM relative to the low voltage power rail in response to the voltage associated with the VCM becoming greater than the voltage associated with the low voltage power rail.

18. A voice coil motor (VCM) drive system comprising:
means for directing a VCM current through the VCM in one of a first direction corresponding to retraction of a magnetic disk read/write head and a second direction corresponding to extension of the magnetic disk read/write head in response to switching control signals;
means for measuring a back-electromotive force (BEMF) voltage across the VCM that corresponds to a retraction velocity of the magnetic disk read/write head; and
means for controlling a retraction velocity of the magnetic disk read/write head by generating the switching control signals to direct the VCM current through the VCM in the first direction to increase the retraction velocity of the magnetic disk read/write head and to direct the VCM current through the VCM in the second direction to decrease the retraction velocity of the magnetic disk read/write head during a retraction mode of the VCM drive system.

19. The system of claim 18, further comprising means for setting a first threshold corresponding to a maximum desired retraction velocity of the magnetic disk read/write head and a second threshold corresponding to a minimum desired retraction velocity of the magnetic disk read/write head in response to a digital threshold selection signal, the means for directing the VCM current directing the VCM current through the VCM in the first direction in response to the measured BEMF voltage being less than the second threshold and in the second direction in response to the measured BEMF voltage being greater than the first threshold.

20. The system of claim 18, further comprising means for monitoring a voltage associated with the VCM relative to a voltage associated with a low voltage power rail of the means for directing the VCM current and for providing a signal to the means for generating the switching control signals to sample the BEMF voltage in response to the voltage associated with the VCM becoming greater than the voltage associated with the low voltage power rail.
